(19) United States
(12) Patent Application Publication
(10) Pub. No.: US 2008/0266539 A1
(43) Pub. Date: Oct. 30, 2008

(54) Exposure system, device production system, exposure method, and device production method

(75) Inventors: Kei Nara, Yokohama-shi (JP); Seiji Miyazaki, Zushi-shi (JP); Yasuo Aoki, Zushi-shi (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/213,730

(22) Filed: Jun. 24, 2008

Related U.S. Application Data
(63) Continuation of application No. PCT/JP2006/326159, filed on Dec. 27, 2006.

(30) Foreign Application Priority Data
Dec. 28, 2005 (JP) 2005-379081

(51) Int. Cl. G03B 27/42; G03B 27/58

(52) U.S. Cl. 355/53; 355/72

(57) ABSTRACT

A device production system includes a substrate transport section which transports a substrate; a plurality of exposure sections each of which is capable of exposing the substrate; and a controller which cooperatively controls the substrate transport section and the plurality of exposure sections so that operation states of the plurality of exposure sections are in desired states. Accordingly, it is possible to improve the efficiency both in using the substrate and in the device production.

### CROSS-REFERENCE

This application is a Continuation Application of International Application No. PCT/JP2006/0326159 which was filed on Dec. 27, 2006 claiming the conventional priority of Japanese patent Application No. 2005-379081 filed on Dec. 28, 2005.

### BACKGROUND OF THE INVENTION

1. Field of the Invention

The present invention relates to an exposure system, a device production system, an exposure method, and a device production method for producing a microdevice including a flat panel display element such as a liquid crystal display element, etc. by the lithography step.

2. Description of the Related Art

The liquid crystal display device and the semiconductor device are produced by the technique of the so-called photolithography in which a pattern formed on a mask is transferred onto a photosensitive substrate. In an exposure apparatus used in the photolithography step, the mask is illuminated with an exposure light, and the pattern of the mask is transferred onto the substrate via the projection optical system. In recent years, the scanning type exposure apparatus is dominantly used, in which the mask is scanned with the exposure light while synchronously moving the mask and the substrate. In relation to such an exposure apparatus, it is required to improve the productivity in order to realize the reduction in the cost for producing the device. In order to improve the productivity, a technique is disclosed, wherein a first exposure station and a second exposure station, which perform the exposure for a substrate, are provided; and a first area on the substrate is subjected to a first exposure in the first exposure station, and then a second area, which is different from a first area on the substrate, is continuously subjected to a second exposure in the second exposure station (see, for example, Japanese Patent Application Laid-open No. 2005-92137).

### SUMMARY OF THE INVENTION

### Task to be Solved by the Invention

As the liquid crystal display element becomes larger, a flat panel display device, for example, a glass substrate on which a liquid crystal display element is to be formed becomes larger. For example, a liquid crystal television, which has a screen as large as exceeding 50 inches, is introduced into the market. The exposure time required for the exposure apparatus is prolonged as the glass substrate becomes large-sized, and the productivity of the device is lowered. A coating apparatus (coating device or coating section) which coats the substrate with a photoresist (photosensitive material) before the exposure and a developing apparatus (developing device or developing section) which develops the substrate, for which the exposure has been completed, have approximately constant processing times irrelevant to a pattern or patterns formed on the substrate and the layout of the pattern(s). On the contrary, the processing time of the exposure apparatus differs depending on, for example, the size of the substrate, the layout, and the type of the pattern.

For example, as shown in FIG. 20, a layout is assumed, in which six areas of screens R55 for panels each having a diagonal length of 55 inches are comparted on a large-sized glass substrate G (for example, a size of 2200 mm×2400 mm). When each of the areas is exposed with a predetermined pattern by using the scanning exposure apparatus as described above, a scanning exposure time, which corresponds to six operations, is required (six scans), because the scanning exposure is performed for each of the areas. On the other hand, as shown in FIG. 19, when eight areas of screens R45 for panels each having a diagonal length of 47 inches are comparted on a large-sized glass substrate G having the same size (2200 mm×2400 mm), and each of the areas is exposed with a predetermined pattern, then the two areas can be simultaneously exposed by one time of the scanning exposure, because the exposure area of the exposure apparatus can cover the two areas. Therefore, in the case of the layout shown in FIG. 19, a scanning exposure time, which corresponds to four operations, is enough for the period of time required to expose the entire glass substrate G (four scans). As described above, even in the case of the glass substrates having the same size, the exposure time differs depending on the difference in the layout (size) adapted to various devices to be produced. On the other hand, the process for patterning the device by the photolithography step is performed over a plurality of layers, wherein the processing time differs between the exposure step for the first layer, the exposure steps for the second layer thereafter, for the following reason. That is, the exposure step for the first layer does not require any alignment (positional adjustment) which needs to be performed, in the exposure steps for the second layer and thereafter, in relation to the previously formed layer. As described above, in the exposure step performed by the exposure apparatus, the exposure time differs depending on the layout (size) and the layer as the exposure objective (depending on exposure sequence for each layer) even when the substrate has the same size. On the contrary, the processes are performed collectively irrelevant to the layout of the substrate, in the film-forming apparatuses including a coater-developer (coater/developer apparatus), an etching apparatus, a sputtering apparatus, etc. which are used in the device production line. Therefore, the processing times of these apparatuses are approximately constant. Therefore, the processing times (tact times) of the respective apparatuses in the device production line in the factory are sometimes affected by the exposure time required for the exposure apparatus.

When the size of the device to be produced is unbalanced with or conforming to the size of the glass substrate, it is desirable that the devices of a plurality of types are efficiently produced with one piece of the glass substrate so as to improve the efficiency of use of the expensive glass substrate. In particular, in the device production line, substrate lots having different device sizes and types are supplied. For the exposure apparatus also, it is desirable that the substrate layout is instantaneously changed to an optimum substrate layout for each of the lots to continue the exposure.

An object of the present invention is to provide an exposure system, a device production system, an exposure method, and a device production method which make it possible to improve the device production efficiency. Another object of the present invention is to provide an exposure system, a device production system, an exposure method, and a device production method which make it possible to improve the efficiency of use of the substrate.

### Solution for the Task

In order to achieve the objects as described above, the present invention adopts the following constructions corresponding to respective drawings as illustrated in embodiments.

According to a first aspect of the present invention, there is provided a device production system comprising a substrate transport section which transports substrates; a plurality of exposure sections which are capable of exposing the substrates respectively; and a controller which cooperatively controls the substrate transport section and the plurality of exposure sections so that operation states of the plurality of exposure sections are in desired states.

According to a second aspect of the present invention, there is provided an exposure system which performs a substrate exposure process to expose substrates and which delivers the substrates with respect to an external processing apparatus performing another process different from the substrate exposure process, the exposure system comprising: first and second exposure sections each of which exposes one of the substrates; and a controller which controls the first and second exposure sections so that the first and second exposure sections alternately receive the substrates from the external processing apparatus and discharge the substrates to the external processing apparatus.

According to the exposure system of the second aspect, the controller controls the first and second exposure sections so that the reception and discharge of the substrate can be performed alternately by the first and second exposure sections. Therefore, the exposure system can always continuously perform the delivery of the substrate with respect to the external processing apparatus irrelevant to the exposure time and the layout of the substrate in the lot supplied to the exposure apparatus.

According to a third aspect of the present invention, there is provided an exposure system which exposes a substrate, the exposure system comprising: first and second exposure sections which expose, with a plurality of patterns, one piece of the substrate in a shared manner; an exposure data-preparing section which prepares first exposure data and second exposure data, for exposing the substrate by the first and second exposure sections respectively in the shared manner, in accordance with exposure information of one piece of the substrate inputted into the exposure system; and a controller which controls the first exposure section and the second exposure section based on the first exposure data and the second exposure data prepared by the exposure data-preparing section.

According to the exposure system of the third aspect of the present invention, the exposure data-preparing section prepares the exposure data, to be subjected to the exposure in the first and second exposure sections, in the shared manner. Therefore, the substrate can be exposed efficiently by using the first and second exposure sections.

According to a fourth aspect of the present invention, there is provided an exposure system which exposes substrates, the exposure system comprising: first and second exposure sections each of which exposes one of the substrates; and a controller which controls the first and second exposure sections; wherein the controller has, in a switchable manner, a first control mode in which the first and second exposure sections are controlled so that a substrate among the substrates loaded and exposed in the first exposure section and unloaded out of the first exposure section is different from a substrate loaded and exposed in the second exposure station and unloaded out of the second exposure section, and in which the first and second exposure sections alternately perform reception of the substrate from an external processing apparatus and discharge of the substrate to the external processing apparatus, the external processing apparatus performing a process different from the exposure of the substrate; and a second control mode in which the substrate loaded in the first exposure section is same as the substrate loaded in the second exposure section, and different areas of the substrate are exposed in a shared manner between the first and second exposure sections.

According to the exposure system of the fourth aspect of the present invention, the controller has the first control mode and the second control mode switchably. Therefore, even when lots of the substrate (substrate lots) having various sizes and layouts are supplied in the device production line, the substrates can be efficiently exposed by using the first and second exposure sections.

According to a fifth aspect of the present invention, there is provided an exposure method for exposing substrates, supplied from an external apparatus, by an exposure apparatus, the exposure method comprising: supplying the substrates alternately to a first exposure section and a second exposure section from the external apparatus at intervals of time t₀; exposing each of the substrates with a predetermined pattern in one of the first exposure section and the second exposure section to which the substrates are alternately supplied; and discharging the exposed substrates alternately from the first exposure section and the second exposure section; wherein an exposure processing time t₁ in the first exposure section and an exposure processing time t₂ in the second exposure section satisfy t₁, t₂>t₀.

According to the fifth aspect of the present invention, the first and second exposure sections are capable of alternately performing the reception and the discharge of the substrate. Therefore, the substrate can be continuously delivered with respect to the external apparatus irrelevant to the exposure time and the layout of the substrate lot supplied to the exposure apparatus.

According to a sixth aspect of the present invention, there is provided a device production system comprising the exposure system as defined in any one of the foregoing aspects; a coater/developer apparatus which coats a substrate with a photosensitive material before an exposure process in the exposure system and which develops the substrate after the exposure process; and a transport apparatus which transports the substrate with respect to the exposure system and the coater/developer apparatus.

A device production method according to the present invention comprises an exposing step of exposing a substrate with a predetermined pattern by using the exposure system, the device production system, or the exposure method as defined in any one of the foregoing aspects; and a developing step of developing the substrate exposed in the exposing step.

By using the exposure system of the present invention, it is possible to improve the throughput of the device production line even when the substrate is large-sized. In particular, by selecting the optimum exposure control mode, using the first and second exposure sections, depending on the pattern size and the layout of the substrate lot, it is possible to maintain the maximum throughput of the device production line without lowering the operation efficiency of the device production line. According to the device production system of the present invention, it is possible to efficiently perform the exposure and to improve the throughput because the device production system is provided with the controller which cooperatively controls the substrate transport section and the plurality of exposure sections. Further, one piece of the substrate can be exposed with the different patterns by the plurality of exposure sections. Therefore, it is possible to improve the efficiency of use of the substrate, and it is possible to improve the device production efficiency.

According to the device production method of the present invention, the device is produced by the device production system or the exposure system of the present invention. Therefore, the satisfactory device can be obtained at a high throughput.

### BRIEF DESCRIPTION OF THE DRAWINGS

FIG. 1 shows a construction of a device production system according to a first embodiment.

FIG. 2 shows areas of a substrate, in which devices are to be formed, according to a second embodiment.

FIG. 3 shows another example of areas, of a substrate, in which devices are to be formed, according to the second embodiment.

FIG. 4 shows still another example of areas, of a substrate, in which devices are to be formed, according to the second embodiment.

FIG. 5 shows another construction of a device production system according to the first embodiment.

FIG. 6 shows a sectional view illustrating a schematic structure of an exposure system of the present invention.

FIG. 7 shows a perspective view illustrating the schematic structure of the exposure system of the present invention.

FIG. 8 illustrates the delivery of substrates between a coater/developer apparatus and the exposure system of the first embodiment.

FIG. 9 shows a flow chart illustrating the delivery of the substrates between the coater/developer apparatus and the exposure system of the first embodiment.

FIG. 10 illustrates a process of a device production line including the exposure system of the first embodiment.

FIG. 11 shows a block diagram illustrating a structure of a primary controller of an exposure system of the second embodiment.

FIG. 12 shows a flow chart illustrating the data-preparing process in a primary controller of the exposure system of the second embodiment.

FIG. 13 shows an example of the layout of a substrate to be exposed in the exposure system of the second embodiment.

FIG. 14 shows a flow chart illustrating an exposure schedule in the exposure system of the second embodiment.

FIG. 15 illustrates a primary controller including three control modes in an exposure system of a third embodiment.

FIG. 16 shows a construction of a device production system according to the third embodiment.

FIG. 17 shows a flow chart illustrating a method for producing a semiconductor device as a microdevice, according to an embodiment of the present invention.

FIG. 18 shows a flow chart illustrating a method for producing a liquid crystal display element as a microdevice, according to an embodiment of the present invention.

FIG. 19 shows a layout of 47-inch screens to be formed on a glass substrate.

FIG. 20 shows a layout of 55-inch screens to be formed on a glass substrate.

### BEST MODE FOR CARRYING OUT THE INVENTION

### First Embodiment

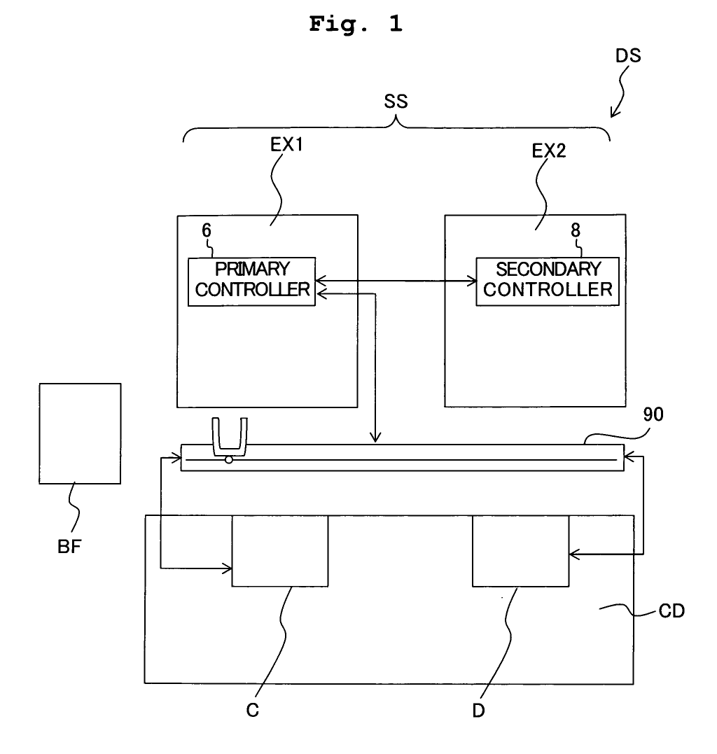

A device production system according to a first embodiment of the present invention will be explained below with reference to the drawings. FIGS. 1, 6, and 7 shows the construction of a device production system DS according to the first embodiment. The device production system includes an exposure system SS which includes a primary exposure apparatus (primary exposure section or first exposure section) EX1 and a secondary exposure apparatus (secondary exposure section or second exposure section) EX2; a coater/developer apparatus CD; and a substrate stock chamber BF which temporarily stores substrates. The device production system is provided with a transport apparatus (substrate transport section) 90 which has at least two transport sections (substrate transport devices, not shown) which transport the substrates between the primary exposure apparatus EX1 and the secondary exposure apparatus EX2; between the primary and secondary exposure apparatuses EX1, EX2 and the coater/developer apparatus CD; and between the primary and secondary exposure apparatuses EX1, EX2 and the coater/developer apparatus CD and the substrate stock chamber BF. The at least two transport sections are constructed so that the transport sections are capable of individually transporting the substrates to the primary exposure apparatus EX1 and the secondary exposure apparatus EX2, respectively. The exposure system SS or the coater/developer apparatus CD may be provided with the transport apparatus 90. Alternatively, one transport section may be used commonly for both of the primary exposure apparatus EX1 and the secondary exposure apparatus EX2.

The coater/developer apparatus CD is provided with a coating apparatus (coating section or coater) C which coats, with the photoresist (photosensitive material), a substrate before the substrate is subjected to the exposure process; and a developing apparatus (developing section or developer) D which develops the substrate after the substrate has been subjected to the exposure process in at least one of the primary exposure apparatus EX1 and the secondary exposure apparatus EX2. The substrate, which is coated with the photoresist by the coating section C, is transported to the primary exposure apparatus EX1 or the secondary exposure apparatus EX2 by the transport apparatus 90.

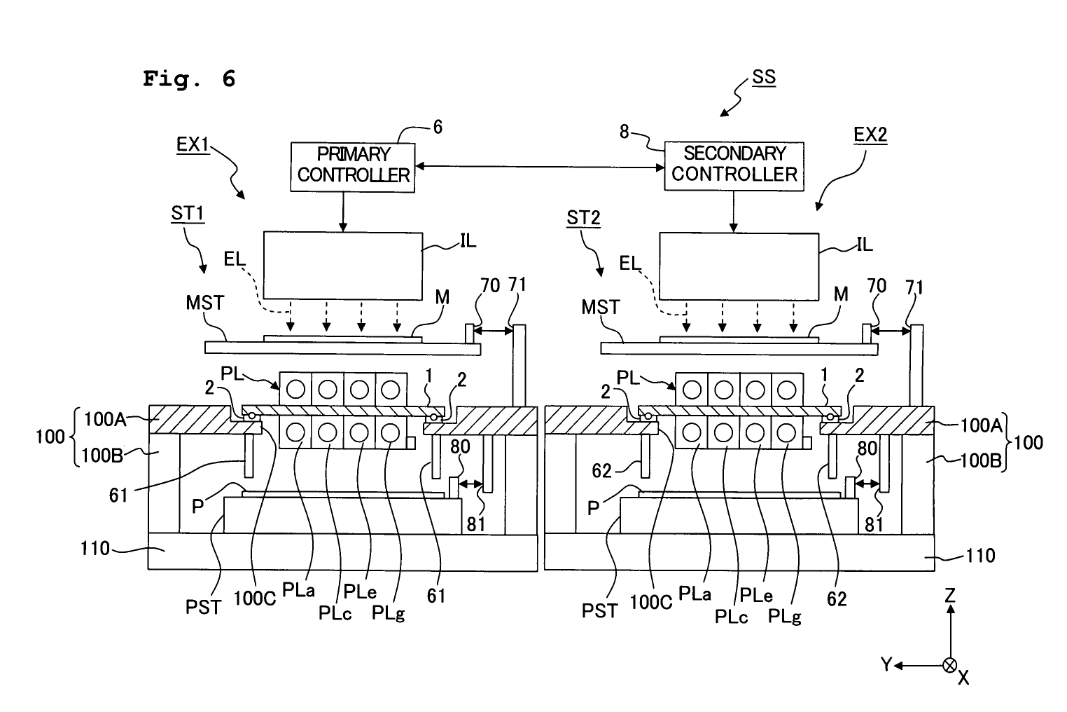

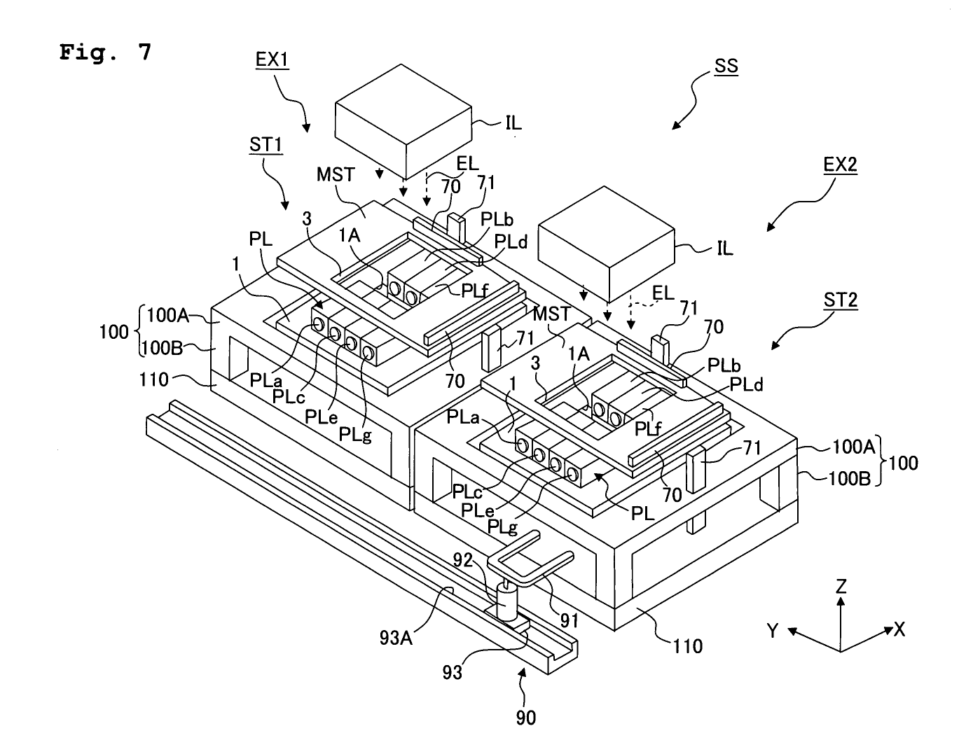

An explanation will be made with reference to FIGS. 6 and 7 about the primary exposure apparatus EX1 and the secondary exposure apparatus EX2 constructing the exposure system SS. In each of the primary exposure apparatus EX1 and the secondary exposure apparatus EX2, a pattern of a mask M, which is illuminated with an exposure-illumination light (exposure light) EL from an illumination system IL, is transferred via a projection optical system PL to perform the exposure on a substrate for a flat panel display element having a size in which the outer diameter exceeds 500 mm, the substrate being transported by the transport apparatus 90. The phrase “size, in which the outer diameter exceeds 500 mm” means a size in which one side or a diagonal line of the substrate exceeds 500 mm.

The primary exposure apparatus EX1 includes a mask stage MST which supports a mask M in which a pattern is formed, a substrate stage PST which supports a photosensitive substrate P, an illumination optical system IL which illuminates the mask M supported by the mask stage MST with the exposure light EL, a projection optical system PL which projects the image of the mask M illuminated with the exposure light EL onto the photosensitive substrate P supported by the substrate stage PST, and a column 100 which supports the projection optical system PL by the aid of a surface plate 1. The column 100 has an upper plate section 100A, and leg sections 100B which extend downwardly from the four corners of the upper plate section 100A respectively. The column 100 is installed on a base plate 110 which is placed horizontally on the floor surface. In this embodiment, the projection optical system PL has a plurality of (seven in this embodiment) aligned projection optical modules PLa to PLg. The illumination optical system IL also has a plurality of (seven) illumination optical modules corresponding to the number and the arrangement of the projection optical modules. Although the photosensitive substrate P is prepared by coating a glass substrate with the photosensitive material (photoresist), it is also allowable that a film such as a protective film or an antireflection film may be formed on the photosensitive layer of the glass substrate.

In this case, the exposure system SS according to the embodiment of the present invention is a scanning type exposure apparatus in which the mask M and the photosensitive substrate P are synchronously moved with respect to the projection optical system PL to perform the scanning exposure. The exposure system SS constitutes the so-called multilens scan type exposure apparatus. In the following description, an X axis direction (scanning direction) is a synchronous movement direction of the mask M and the photosensitive substrate P, an Y axis direction (non-scanning direction) is a direction which is perpendicular to the X axis direction in a horizontal plane, and a Z axis direction is a direction which is perpendicular to the X axis direction and the Y axis direction. The respective directions about the X axis, the Y axis, and the Z axis are designated as θX, θY, and θZ directions respectively.

Although not shown, the illumination system IL includes a plurality of light sources, a light guide which once collects light fluxes radiated from the plurality of light sources and which then distributes the collected light flux equivalently to effect the radiation; an optical integrator which converts the light flux from the light guide into a light flux (exposure light) having a uniform illuminance distribution; a blind section which has an aperture for defining, on the mask M, the radiation area (illumination area) of the exposure light from the optical integrator; and a condenser lens which focuses the exposure light passing through the blind section on the mask M. The exposure light from the condenser lens illuminates a plurality of rectangular illumination areas on the mask M. In this embodiment, a mercury lamp is used for the light source; and as the exposure light, g-ray (436 nm), h-ray (405 nm), i-ray (365 nm), etc. which have the wavelengths required for the exposure are used by the aid of an unillustrated wavelength selection filter. It is also possible to use far ultraviolet light such as the ArF excimer laser beam.

The mask stage MST is movable in the X axis direction, the Y axis direction, and the θZ direction by a driving device such as a linear motor in a state that the mask M is supported on the mask stage MST. The linear motor may be a so-called moving magnet type linear motor in which the stator is constructed by a coil unit (armature unit) and the mover is constructed by a magnet unit. Alternatively, the linear motor may be a so-called moving coil type linear motor in which the stator is constructed by a magnet unit and the mover is constructed by a coil unit. The mover is driven in accordance with the electromagnetic interaction with respect to the stator, thereby moving the mask stage MST. A chuck mechanism having vacuum suction holes is provided for the mask stage MST. The mask stage MST holds the mask M by the aid of the chuck mechanism. An opening 3 (see FIG. 7), through which the exposure light EL transmitted through the mask M is passable, is provided at the central portion of the mask stage MST.

Movement mirrors 70 are provided at an end edge on the +X side and an end edge on the −Y side of the mask stage MST respectively. Laser interferometers 71 are provided, of which parts are arranged opposite to or facing the movement mirrors 70, respectively. The laser interferometers 71 are arranged on the upper plate section 100A of the column 100. The position in the two-dimensional direction and the angle of rotation of the mask M on the mask stage MST are measured in real-time by the laser interferometers 71. Obtained results of the measurement are outputted to the control system CONT. The control system CONT drives the mask stage-driving device based on the results of the measurement of the laser interferometers 71, to thereby position the mask M supported by the mask stage MST.

The projection optical system PL has the plurality of (seven) aligned projection optical modules PLa to PLg. The plurality of projection optical modules PLa to PLg are supported by one surface plate 1. Among the plurality of projection optical modules PLa to PLg, the projection optical modules PLa, PLc, PLe, PLg are arranged and aligned in a row in the Y axis direction; and the projection optical modules PLb, PLd, PLf are arranged and aligned in a row in the Y axis direction. The projection optical modules PLa, PLc, PLe, PLg aligned in the Y axis direction and the projection optical modules PLb, PLd, PLf aligned in the Y axis direction are arranged so that they are opposed to one another in the X axis direction. Seven exposure areas (projection areas in which the projected image of the pattern of the mask M is generated) AR, which are irradiated with the exposure light EL via the projection optical modules PLa to PLg, are arranged in a zigzag form on the substrate P as a whole. That is, the respective projection optical modules PLa to PLg, for which the exposure areas AR are arranged in the zigzag form, are arranged such that adjoining projection optical modules (for example, the projection optical modules PLa and PLb, PLb and PLc) among the plurality of the optical modules are displaced or shifted in the Y axis direction by a predetermined amount. In this embodiment, the exposure area AR is defined to have a rectangular shape.

Each of the projection optical modules PLa to PLg is constructed of a plurality of optical elements, and includes a field diaphragm which defines the exposure area (projection area), an image formation characteristic-adjusting device, and the like. The image formation characteristic-adjusting device adjusts the image formation characteristic of an image of a pattern (pattern image) by driving a specified optical element among a plurality of optical elements. The image formation characteristic-adjusting device is capable of adjusting the image shift, the scaling, the rotation, the image plane position (image plane inclination), and the like. The optical elements (for example, lenses), which constitute each of the projection optical modules PLa to PLg, are arranged in a barrel. As for the image formation characteristic-adjusting device, it is also allowable to use, for example, a mechanism in which the space between a part of the optical elements (lenses) is hermetically sealed to adjust the internal pressure.

The surface plate 1 is kinematically supported with respect to the upper plate section 100A via a support section 2. An opening 100C is provided at the central portion of the upper plate section 100A. The surface plate 1 is supported on the circumferential edge portion of the opening 100C of the upper plate section 100A. The lower portion of each of the projection optical modules PLa to PLg is arranged in the opening 100C. Further, an opening is formed at the central portion of the surface plate 1. The opening secures the optical path for the exposure light EL for each of the projection optical modules PLa to PLg. The surface plate 1 is formed of, for example, a metal matrix composite material (MMC: Metal Matrix Composites). The metal matrix composite material is a composite material in which a metal is used as a matrix material and a ceramics reinforcing material is compounded therein. In this case, a material containing aluminum is used as the metal. In FIG. 6, a stepped portion is formed at the circumferential edge portion of the opening 100C, and the support section 2 is provided at the stepped portion. However, the upper plate section 100A may be a flat surface.

The substrate stage PST is provided on the base plate 110. The substrate stage PST is movable in the X axis direction, the Y axis direction, and the θZ direction by a driving device such as a linear motor while supporting the photosensitive substrate P. Further, the substrate stage PST is also movable in the Z axis direction, the θX direction, and the θY direction. The linear motor may be a moving magnet type linear motor or a moving coil type linear motor. The mover is driven in accordance with the electromagnetic interaction with respect to the stator, thereby moving the substrate stage PST. A chuck mechanism having vacuum suction holes is provided for the substrate stage PST. The substrate stage PST holds the photosensitive substrate P via the chuck mechanism.

Reflecting mirrors 80 for the X axis and the Y axis are provided respectively at an end edge on the +X side and an end edge on the −Y side of the substrate stage PST. There are provided a laser interferometer for the X axis (not shown) of which part is arranged opposite to or facing the reflecting mirror for the X axis, and a laser interferometer 81 for the Y axis of which part is arranged opposite to or facing the reflecting mirror 80 for the Y axis. The laser interferometer for the X axis has two length-measuring axes, and the laser interferometer is capable of measuring the angle of rotation also in the θZ direction. In the following description, the laser interferometers for the X axis and the Y axis are collectively referred to as “laser interferometer 81”. The laser interferometer 81 is attached to a lower portion of the upper plate section 100A of the column 100. The position in the two-dimensional direction and the angle of rotation of the photosensitive substrate P on the substrate stage PST are measured in real-time by the laser interferometer 81. Obtained results of the measurement are outputted to the control system CONT. The control system CONT drives the substrate stage-driving device based on the result of the measurement of the laser interferometer 81, to thereby position the photosensitive substrate P supported by the substrate stage PST.

Although not shown, for example, an autofocus detecting system, which detects the position of a pattern formation surface of the mask M and an exposure objective surface of the photosensitive substrate P in the Z axis direction, is provided between the projection optical modules PLa, PLc, PLe, PLg on the −X side and the projection optical modules PLb, PLd, PLf on the +X side. The optical element of the projection optical module and/or the substrate stage PST is driven, based on a result of the detection of the autofocus detecting system, so that the image plane of the projection optical system PL is coincident with the exposure objective surface (surface) of the photosensitive substrate P. Although not shown, for example, a plurality of alignment systems of the off-axis system (mark-detecting systems) are provided. The unillustrated alignment systems have detecting areas with different positions in relation to the Y axis direction, and each of the alignment systems detects an alignment mark on the photosensitive substrate P. In the exposure of the second layer and thereafter of the photosensitive substrate P, the substrate stage PST is driven based on a result of the detection of the alignment system. In order to overlay and transfer a pattern of the next layer on the pattern having been formed on the photosensitive substrate P. In this embodiment, at least a part of each of the autofocus detecting system and at least a part of the alignment system are provided on the upper plate section 100A of the column 100.

The primary exposure apparatus EX1 has been explained above. Since the secondary exposure apparatus EX2 is constructed approximately equivalently to the primary exposure apparatus EX1, any explanation therefor will be omitted.

Here, as shown in FIG. 6, the primary exposure apparatus EX1 is provided with a mark-forming device 61 to which the photosensitive substrate P supported by the substrate stage PST is arranged opposite or facing. The mark-forming device 61 is attached to a lower portion of the upper plate section 100A of the column 100 of the primary exposure apparatus EX1, and the mark-forming device 61 forms, on the photosensitive substrate P, a mark (screen-arranging mark) to be used when the photosensitive substrate P is positioned with respect to the predetermined position. In this embodiment, two pieces of the mark-forming device 61 are provided. On the other hand, the secondary exposure apparatus EX2 is provided with a mark-detecting device 62 which detects the mark formed on the photosensitive substrate P by the mark-forming device 61 provided for the primary exposure apparatus EX1. The mark-detecting device 62 is attached to a lower portion of the upper plate section 100A of the column 100 of the secondary exposure apparatus EX2. By detecting the mark formed on the photosensitive substrate P by the mark-forming device 61 of the primary exposure apparatus EX1, it is possible to detect the position of a shot area (especially an exposure pattern of the first layer) on the photosensitive substrate P having been exposed by the primary exposure apparatus EX1. As described later on, the mark-detecting device 62 outputs the detection result to the secondary controller 8. Based on the detection result, the secondary controller 8 can correctly position the shot area to be exposed in the secondary exposure apparatus EX2 with respect to the shot area having been already formed on the substrate P. In this embodiment, two piece of the mark-detecting device 62 are provided corresponding to the two mark-forming devices 61. The mark-forming devices 61 provided for the primary exposure apparatus EX1 and the mark-detecting devices 62 provided for the secondary exposure apparatus EX2 are used in the exposure operation as explained in a second embodiment described later on.

As shown in FIG. 7, the exposure system SS is provided with a transport apparatus (loader system) 90 which transports the photosensitive substrate P. The transport apparatus 90 includes a hand section 91 which is capable of holding the photosensitive substrate P, a first driving section 92 which drives the hand section 91, and a second driving section 93 which moves the hand section 91 together with the first driving section 92. The second driving section 93 moves the hand section 91 together with the first driving section 92 in the Y axis direction along a guide section 93A which extends in the Y axis direction. The transport apparatus (loader system) 90 is capable of loading a photosensitive substrate P, which has not been subjected to the exposure process (before the exposure process) and which is transported from the coating section C, into the substrate stage PST of any one of the primary exposure apparatus EX1 and the secondary exposure apparatus EX2. Further, the transport apparatus 90 is capable of transporting the photosensitive substrate P between the substrate stage PST of the primary exposure apparatus EX1 and the substrate stage PST of the secondary exposure apparatus EX2. That is, the transport apparatus 90 is capable of unloading, from the substrate stage PST, the photosensitive substrate P having been subjected to the exposure process in the primary exposure apparatus EX1 (or the secondary exposure apparatus EX2), and the transport apparatus 90 is capable of loading the photosensitive substrate P on the substrate stage PST of the secondary exposure apparatus EX2 (or the primary exposure apparatus EX1).

In FIG. 7, although one transport apparatus 90 (hand section 91) is shown, the exposure system SS is provided with a plurality of the transport apparatuses 90. For example, a plurality of photosensitive substrates P can be simultaneously loaded or unloaded with respect to the substrate stages PST of the primary exposure apparatus EX1 and the secondary exposure apparatus EX2, by the plurality of transport apparatuses 90, respectively.

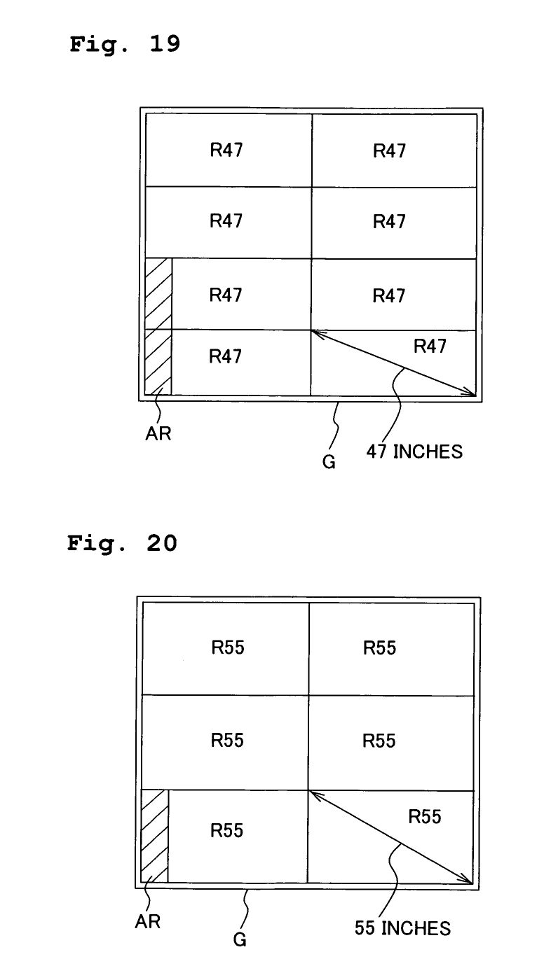

Next, an explanation will be made about the operation in which the substrate is exposed by the primary exposure apparatus EX1 and the secondary exposure apparatus EX2 of the exposure system SS described above. By radiating the exposure light EL onto the substrate P via the projection optical system PL, for example, the exposure area AR as shown in FIG. 19 is formed. In this procedure, one screen among the screens (shot areas) defined on the substrate is exposed with the exposure light EL via the mask M and the projection optical system PL by synchronously performing the movement of the mask stage MST supporting the mask M with relative to the plurality of illumination areas and the movement of the substrate stage PST supporting the substrate P relative to the exposure area AR in relation to the scanning direction (X axis direction). Subsequently, the substrate stage PST is moved so that another screen on the substrate P is exposed, and the another screen is subjected to the scanning exposure in the same manner as described above. This operation is repeated until all of the screens defined on the substrate P are exposed. In the case of the layout shown in FIG. 19, each of the exposure apparatuses EX1, EX2 can expose the two screens by one time of the scanning exposure, and hence the scanning exposure is performed four times. In the case of the layout shown in FIG. 20, the scanning exposure is performed six times.

The substrate, which has been exposed by the primary exposure apparatus EX1 or the secondary exposure apparatus EX2, is transported by the transport apparatus 90 to the developing section D provided for the coater/developer apparatus CD.

Masks, which have mutually different patterns, may be used for the primary exposure apparatus EX1 and the secondary exposure apparatus EX2. However, in this embodiment, masks having a same pattern are used. The photosensitive substrates are exposed with the same pattern in the primary exposure apparatus EX1 and the secondary exposure apparatus EX2 respectively. Each of the primary exposure apparatus EX1 and the secondary exposure apparatus EX2 may be provided with a mask library for stocking a plurality of masks formed with different patterns, a mask transport section (not shown) for transporting the mask, etc. Alternatively, one piece of the mask library and one piece of the mask transport section may be provided commonly for the primary exposure apparatus EX1 and the secondary exposure apparatus EX2.

With reference to FIG. 1 again, the primary exposure apparatus EX1 is provided with the primary controller (controller) 6 which integrally controls the entire operation of the primary exposure apparatus EX1 and the device production system. That is, the primary controller 6 cooperatively controls the operations of the transport apparatus 90, the primary exposure apparatus EX1, and the secondary exposure apparatus EX2 (secondary controller 8 as described later on) so that the operation states of the primary exposure apparatus EX1 and the secondary exposure apparatus EX2 are in desired operation states. In other words, the primary controller 6 outputs the control signal to the secondary controller 8 to dominantly make the control.

Specifically, in accordance with the operation states of the primary exposure apparatus EX1 and the secondary exposure apparatus EX2, the primary controller 6 instructs the transport apparatus 90 to transport a substrate, which has been coated with the photoresist by the coater/developer apparatus CD, to the primary exposure apparatus EX1. Further, in accordance with the operation states of the primary exposure apparatus EX1 and the secondary exposure apparatus EX2, the primary controller 6 instructs the transport apparatus 90 to transport the substrate, which has been exposed by the primary exposure apparatus EX1, to the coater/developer apparatus CD.

The secondary exposure apparatus EX2 is provided with the secondary controller 8 which instructs the transport apparatus 90 with respect to the coater/developer apparatus CD so that the substrate, which has been coated with the photoresist by the coater/developer apparatus CD, is transported to the secondary exposure apparatus EX2 and which controls the secondary exposure apparatus EX2 so that the substrate, which has been exposed by the secondary exposure apparatus EX2, is transported to the coater/developer apparatus CD.

The primary controller 6 controls the instruction by the secondary controller 8 to transport the substrate coated with the photoresist to the secondary exposure apparatus EX2 and the instruction to transport the exposed substrate to the coater/developer apparatus CD, in accordance with the operation states of the primary exposure apparatus EX1 and the secondary exposure apparatus EX2. In this embodiment, the primary controller 6 controls the transport apparatus 90, the primary exposure apparatus EX1, and the secondary exposure apparatus EX2 so that the substrate, which is coated with the photoresist by the coater/developer apparatus CD, is loaded by the transport apparatus 90 alternately into the primary exposure apparatus EX1 and the secondary exposure apparatus EX2; and that the substrate is accepted or received alternately by the primary exposure apparatus EX1 and the secondary exposure apparatus EX2. In this case, the primary controller 6 performs the monitoring so that the primary exposure apparatus EX1 and the secondary exposure apparatus EX2 do not perform any mutually interfering operation. For example, the primary exposure apparatus EX1 and the secondary exposure apparatus EX2 are controlled so that the primary exposure apparatus EX1 and the secondary exposure apparatus EX2 do not simultaneously receive substrates from the transport apparatus 90 and the primary exposure apparatus EX1 and the secondary exposure apparatus EX2 do not simultaneously deliver the substrates to the transport apparatus 90. Therefore, when the primary controller 6 permits the instruction to load the substrate into the secondary exposure apparatus EX2 and the instruction to unload the substrate out of the secondary exposure apparatus EX2, the primary controller 6 outputs a signal of this meaning to the secondary controller 8. When the primary controller 6 does not permit the instruction to load the substrate into the secondary exposure apparatus EX2 and the instruction to unload the substrate out of the secondary exposure apparatus EX2, the primary controller 6 outputs the signal of this meaning.

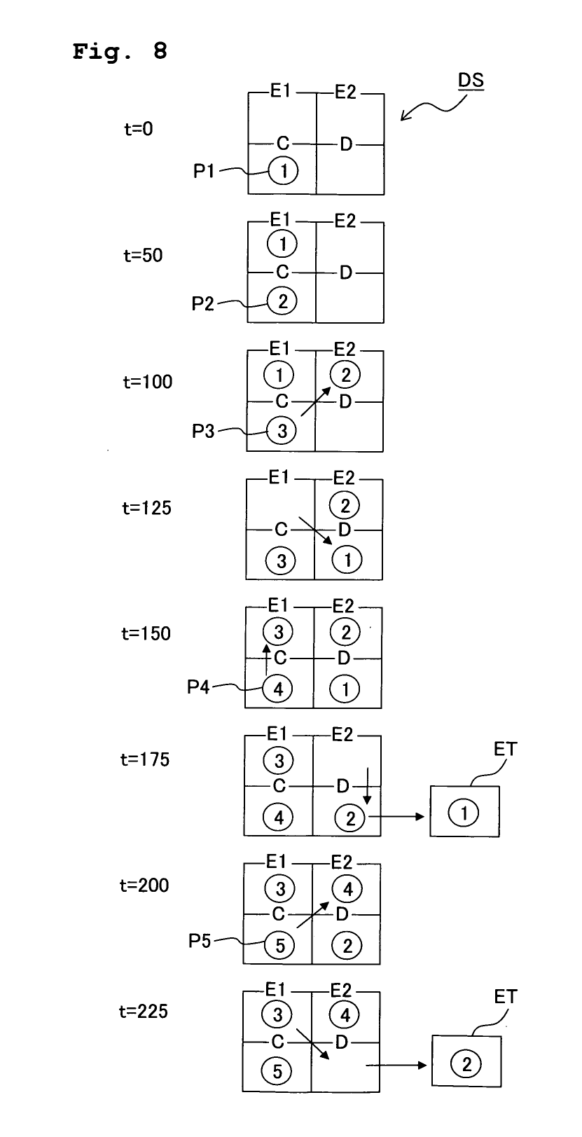

A typical example of the control of the primary controller 6 will be explained with reference to FIG. 8. FIG. 8 shows, in a simplified manner, a portion or portions at which a substrate or substrates are processed at a certain time t in the device production system SS including the primary exposure apparatus EX1, the secondary exposure apparatus EX2, and the coating section C and the developing section D of the coater/developer apparatus CD. Circled numbers affixed to a plurality of substrates indicate the order in which the substrates (five in FIG. 8) a substrate lot are loaded in or into the coating section C. Circled “1” indicates the substrate which is firstly loaded into the coating section C. For the purpose of convenience of the explanation, the transport apparatus 90 is omitted from FIG. 8. It is assumed that the exposure processing time for the first layer to be formed on the substrate is 75 seconds in any one of the primary exposure apparatus EX1 and the secondary exposure apparatus EX2; and the coating processing time and the developing processing time in the coating section C and the developing section D are 50 seconds respectively. In order to simplify the explanation, the following description will be made while intentionally ignoring the time required to transport the substrate by the transport apparatus and the time required to load and unload the substrate (exchange the substrate) in the coating section C, the primary exposure apparatus EX1, the secondary exposure apparatus EX2, and the developing section D.

At the time t=0, a first substrate P1 in the substrate lot is loaded into the coating section C, and the coating of the substrate P1 with the photoresist is started. It is illustrated that at the time t=0 the substrate P exists in only the coating section C. Subsequently, when the coating of the first substrate P1 with the photoresist in the coating section C is completed at the time t=50 seconds, the first substrate P1 is loaded, from the coating section C, into the primary exposure apparatus EX1 by the transport apparatus under the control of the primary controller 6. When the first substrate P1 is loaded into the primary exposure apparatus EX1, the exposure process is started in the primary exposure apparatus EX1. In this situation, a second substrate P2 is loaded into the coating section C, and the coating process is started. The loading of the second substrate P2 is performed promptly after the unloading of the first substrate P1.

The coating process for the second substrate P2 is completed in the coating section C at the time t=100 seconds, and the primary controller 6 controls the transport apparatus and the secondary exposure apparatus EX2 so that the second substrate P2 is loaded into the secondary exposure apparatus EX2 from the coating section C. When the second substrate P2 is delivered to the secondary exposure apparatus EX2, the exposure process is started for the second substrate P2 in the secondary exposure apparatus EX2. At this time, the exposure process for the first substrate P1 is not yet completed in the primary exposure apparatus EX1, because only 50 seconds have elapsed from the start of the exposure. On the other hand, a third substrate P3 is loaded into the coating section C.

At the time t=125 seconds, the exposure process for the first substrate P1 is completed because the exposure processing time in the primary exposure apparatus EX1 arrives at 75 seconds; and the exposed first substrate P1 is unloaded out of the primary exposure apparatus EX1, and the first substrate P1 is transported to the developing section D in accordance with the control of the primary controller 6. At this time, the second substrate P2 is being subjected to the exposure process in the secondary exposure apparatus EX2, and the third substrate P3 is being subjected to the coating process in the coating section C as well.

Subsequently, at the time t=150 seconds, the coating process is completed for the third substrate P3 in the coating section C, and the third substrate P3 is loaded into the primary exposure apparatus EX1 from the coating section C under the control of the primary controller 6; and a fourth substrate P4 is loaded into the coating section C. When the third substrate P3 is delivered to the primary exposure apparatus EX1, the exposure process is started in the primary exposure apparatus EX1. At this time, the exposure process is not yet completed in the secondary exposure apparatus EX2 because only 50 seconds have elapsed from the start of the exposure and also the first substrate P1 is being developed in the developing section D.

At the time t=175 seconds, the developing processing time for the first substrate P1 in the developing section D arrives at 50 seconds. Therefore, the first substrate P1, for which the developing process has been completed, is discharged from the developing section D. The first substrate P1 is then transported to be subjected to the next process, for example, to an etching processing section ET. At the same time, the exposure processing time arrives at 75 seconds in the secondary exposure apparatus EX2, and the exposure process is completed for the second substrate P2. Therefore, the primary controller 6 controls the secondary exposure apparatus EX2 and the transport apparatus so that the exposed second substrate P2 is unloaded out of the secondary exposure apparatus EX2 and is transported to the developing section D. At this time, the third substrate P3 is being subjected to the exposure process in the primary exposure apparatus EX1, and the fourth substrate P4 is being subjected to the coating in the coating section C as well.

At the time t=200 seconds, the coating process is completed for the fourth substrate P4 in the coating section C; and the fourth substrate P4 is loaded into the secondary exposure apparatus EX2 from the coating section C by the transport apparatus under the control of the primary controller 6. A fifth substrate P5 is loaded into the coating section C. When the fourth substrate P4 is delivered to the secondary exposure apparatus EX2, the exposure process is started for the fourth substrate P4 in the secondary exposure apparatus EX2. At this time, the exposure process is not yet completed for the third substrate P3 in the primary exposure apparatus EX1, and the second substrate P2 is being developed in the developing section D as well.

At the time t=225 seconds, since the developing processing time of the second substrate P2 in the developing section D arrives at 50 seconds, the developing process in the developing section D is completed, and the second substrate P2 is discharged from the developing section D and the second substrate P2 is transported to be subjected to the next process, for example, to the etching processing section ET. At the same time, since the exposure process is completed for the third substrate P3 in the primary exposure apparatus EX1, the third substrate P3 is transported from the primary exposure apparatus EX1 to the developing section D under the control of the primary controller 6. At this time, the fourth substrate P4 is being subjected to the exposure process in the secondary exposure apparatus EX2, and the fifth substrate P5 is being subjected to the coating in the coating section C as well.

As described above, in the device production system DS, the substrates of the substrate lot are loaded from the coating section C alternately to the primary exposure apparatus EX1 and the secondary exposure apparatus EX2 under the control of the primary controller 6; and the substrates, for which the exposure is completed in the primary exposure apparatus EX1 and the secondary exposure apparatus EX2, are alternately unloaded to the developing section D. The exposure processing time is 75 seconds in each of the primary exposure apparatus EX1 and the secondary exposure apparatus EX2 as described above. On the contrary, the processing times in the coating section C and the developing section D are 50 seconds respectively, which is shorter than the exposure processing time. If only one exposure apparatus is provided for one coater/developer apparatus CD, the primary controller 6 cannot perform the alternate control as described above. Therefore, a substrate P, which has been subjected to the coating in the coating section C, cannot be transported to the exposure apparatus until the exposure process is completed for the previous substrate in the exposure apparatus. As a result, the waiting time (25 seconds in this example) arises in the coating section C, and thus it is impossible to continue the coating process in the coating section C without discontinuing the coating process in the coating section C. Even if a substrate stock chamber (BF), which temporarily accommodates the coated substrates, is provided, the accommodating ability thereof is limited. Therefore, the device production line is forced to perform the operation in conformity with the exposure processing time in the exposure apparatus. Other apparatuses including, for example, the coater/developer apparatus CD cannot exhibit the maximum performance (because the operation of the coater/developer apparatus CD and the like should be adjusted to the exposure processing time of 75 seconds). Therefore, it is impossible to improve the throughput of the production line. On the contrary, when the exposure system is provided with the two exposure apparatuses of the primary exposure apparatus EX1 and the secondary exposure apparatus EX2 as described above, and the apparatuses are alternately operated, then the coater/developer apparatus CD can be continuously operated without any waiting time.

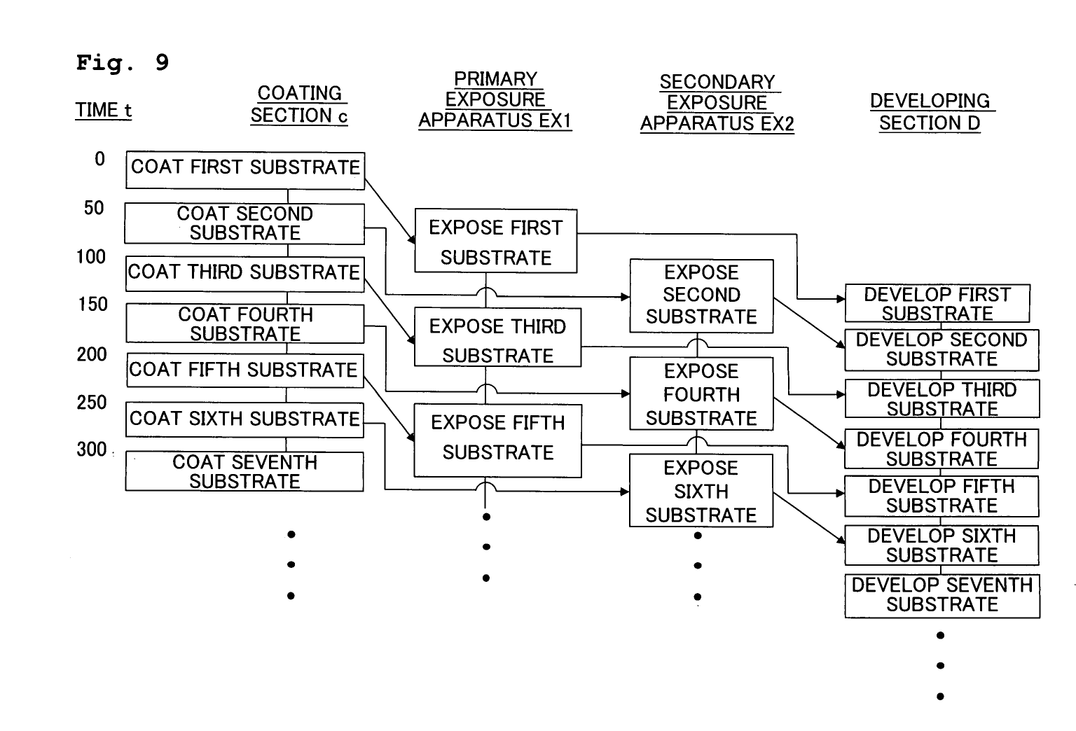

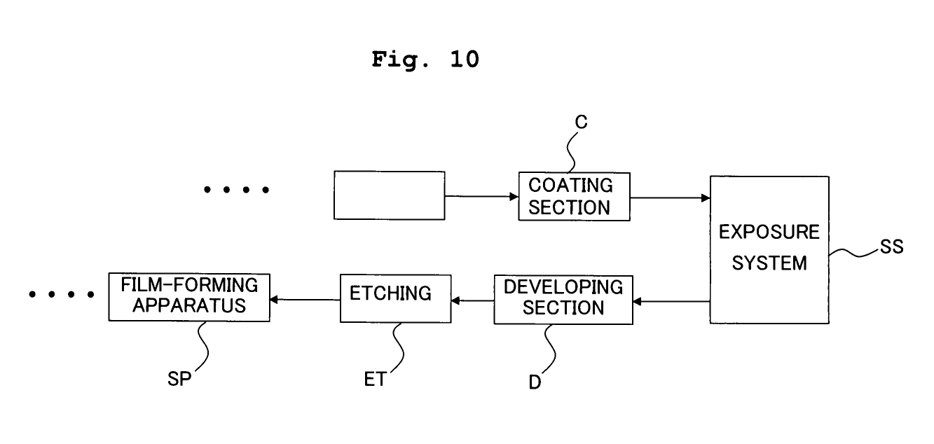

The advantage of the device production system DS and the exposure system SS of the present invention as explained in relation to FIG. 8 will be understood more easily from FIG. 9. FIG. 9 shows, in a timing chart together with the time, the operations performed in the primary exposure apparatus EX1, the secondary exposure apparatus EX2, and the coating section C and the developing section D of the coater/developer apparatus CD of the device production system DS as explained in relation to FIG. 8. The coating section C and the developing section D are continuously operated because their processing times are 50 seconds respectively. On the other hand, the exposure processing times of the primary exposure apparatus EX1 and the secondary exposure apparatus EX2 are 75 seconds respectively. Therefore, a short interval (hereinafter referred to as “exposure interval”; 25 seconds in this embodiment) remains between the exposure processes for the two substrates. The exposure interval differs depending on the layout of a substrate to be exposed and the order of film formation on the substrate to be processed. When the substrates having the layout as shown in FIGS. 19 and 20, in which the number of times of scanning differs (four scans and six scans), are supplied to the production line, the exposure processing time per one substrate differs as well. In the embodiment described above, 75 seconds are required as the exposure processing time in order to expose the first layer on the substrate. However, a longer time (for example, 85 seconds) is required for the second layer and thereafter because it is necessary to perform the alignment process with respect to the pattern of the first layer. Even in such a situation, according to this embodiment, the exposure interval can absorb the difference in the exposure processing time due to the processing condition and the substrate to be subjected to the exposure process. In other words, when the consideration is made about the whole exposure system provided with the primary exposure apparatus EX1 and the secondary exposure apparatus EX2, then the exposure system SS receives a substrate to be exposed from the coating section C always at the interval of 50 seconds, and the exposure system SS discharges an exposed substrate to the developing section D. This means that the exposure system SS, which is capable of performing the exposure process for the substrate always at a constant processing time irrelevant to the layout of the substrate and the exposure process condition on the substrate to be processed (irrelevant to a layer of which order from the uppermost layer is to be exposed), in other words, irrelevant to the exposure processing times in the primary exposure apparatus EX1 and the secondary exposure apparatus EX2, apparently exists on the device production line. As a result, the apparatuses, including the coater/developer apparatus CD, the etching apparatus ET, the film-forming apparatus SP, etc., can be fully operated (continuously operated at the maximum capacities) at the constant processing time (tact time) in a device production line including the exposure system SS of this embodiment as shown in FIG. 10. Thus, it is possible to greatly improve the throughput of the entire production line, thereby solving the problem inherent in the conventional production line such that the entire production line is affected by the exposure processing time.

The primary controller 6 is also capable of controlling the operation states of the transport apparatus 90, the primary exposure apparatus EX1, and the secondary exposure apparatus EX2 based on the number of substrates exposable per unit time by the primary exposure apparatus EX1, the number of substrates exposable per unit time by the secondary exposure apparatus EX2, the number of substrates processable per unit time by the coater/developer apparatus CD, and the number of substrates transportable per unit time by the transport apparatus 90. Specifically, the transport apparatus 90 is controlled so that the ratio between the numbers of substrates to be transported to the respective exposure apparatuses EX1, EX2 is close to the ratio of the numbers of substrates exposable by the exposure apparatuses EX1, EX2, based on the ratio of the numbers of substrates exposable per unit time by the exposure apparatuses EX1, EX2. The following procedure is also allowable. That is, the substrates are mainly exposed by the primary exposure apparatus EX1, in relation to the substrates transported by the transport apparatus 90; and that any number of substrates, which exceeds the number of substrates exposable by the primary exposure apparatus EX1, may be exposed by the secondary exposure apparatus EX2.

In this embodiment, the primary controller 6, provided for the primary exposure apparatus EX1, cooperatively controls the operations of the transport apparatus 90, the primary exposure apparatus EX1, and the secondary exposure apparatus EX2. However, it is also allowable that another master controller (controller) may be provided at the outside of the primary exposure apparatus EX1. In this case, the master controller cooperatively controls the operations of the primary controller 6, the secondary controller 8, and the transport apparatus 90; and the master controller controls the transport apparatus 90 so that the substrates are transported in accordance with the substrate processing request from the primary controller 6 (primary exposure apparatus EX1) and the secondary controller 8 (secondary exposure apparatus EX2). Here, the term “substrate processing request” means a request to load a substrate coated with the photoresist into the primary exposure apparatus EX1 or the secondary exposure apparatus EX2, a request to unload the exposed substrate out of the primary exposure apparatus EX1 or the secondary exposure apparatus EX2 to the coater/developer apparatus CD, etc.

In this embodiment, the primary controller 6 controls the primary exposure apparatus EX1, the secondary exposure apparatus EX2, and the transport apparatus 90. However, the primary controller 6 may control the primary exposure apparatus EX1 and the secondary exposure apparatus EX2, and the transport apparatus 90 may be controlled by a controller of itself or any other apparatus, for example, by the coater/developer apparatus CD.

In this embodiment, the primary controller 6 has the control mode (first control mode or alternate control mode) in which the primary exposure apparatus EX1 and the secondary exposure apparatus EX2 are controlled so that the primary exposure apparatus EX1 and the secondary exposure apparatus EX2 alternately deliver the substrates with respect to the transport apparatus 90, while exposing the substrates P by the primary and secondary exposure apparatuses EX1, EX2 respectively. However, as described below, the primary controller 6 may have a control mode (third control mode or single control mode) in which only one of the primary exposure apparatus EX1 and the secondary exposure apparatus EX2 is driven, wherein the control mode (third control mode or single control mode) is switchable with respect to the first control mode. That is, the primary controller 6 can also select one of the primary exposure apparatus EX1 and the secondary exposure apparatus EX2, for example, can select the secondary exposure apparatus EX2, depending on the substrate processing information including the processing information such as the time required for the exposure by the primary exposure apparatus EX1 and the apparatus information such as the trouble information of the apparatus; and the primary controller 6 can instruct the secondary controller 8 and the transport apparatus 90 to perform the exposure by only the selected secondary exposure apparatus EX2. Further, the primary controller 6 can also select one of the primary exposure apparatus EX1 and the secondary exposure apparatus EX2, for example, select the primary exposure apparatus EX1, depending on the substrate processing information including the processing information such as the time required for the exposure by the secondary exposure apparatus EX2 and the apparatus information such as the trouble information of the apparatus; and the primary controller 6 can make the control to perform the exposure only by the primary exposure apparatus EX1. That is, when any special situation such as the trouble of the apparatus, etc. arises, the transport apparatus 90 and the secondary controller 8 may be controlled so that the transport apparatus 90 is instructed to load the substrate only into the primary exposure apparatus EX1, and that the secondary controller 8 does not permit the instruction to load the substrate into the secondary exposure apparatus EX2. Note that when the exposure cannot be performed by the secondary exposure apparatus EX2, it is also allowable that the secondary controller 8 informs the primary controller 6 that the exposure cannot be performed. The processing information such as the time required for the exposure includes an information about prolongation of the exposure time caused by the deterioration of the illuminance of the illumination system and apparent prolongation of the time required for the exposure caused by the delay in the operation required for the alignment, transport and holding of the substrate. As described above, in ordinary cases, the primary controller 6 operates so that the primary exposure apparatus EX1 and the secondary exposure apparatus EX2 alternately perform delivery of the substrates with respect to the coater/developer apparatus CD via the transport apparatus 90 (first control mode) in order to improve the throughput of the entire production line. However, in any special case, the primary controller 6 can control the primary exposure apparatus EX1 and the secondary exposure apparatus EX2 so that only one of the exposure apparatuses is driven (third control mode). In this way, the device can be produced without stopping the production line, although the throughput of the production line is lowered as compared with the first control mode (alternate substrate delivery mode).

### Second Embodiment

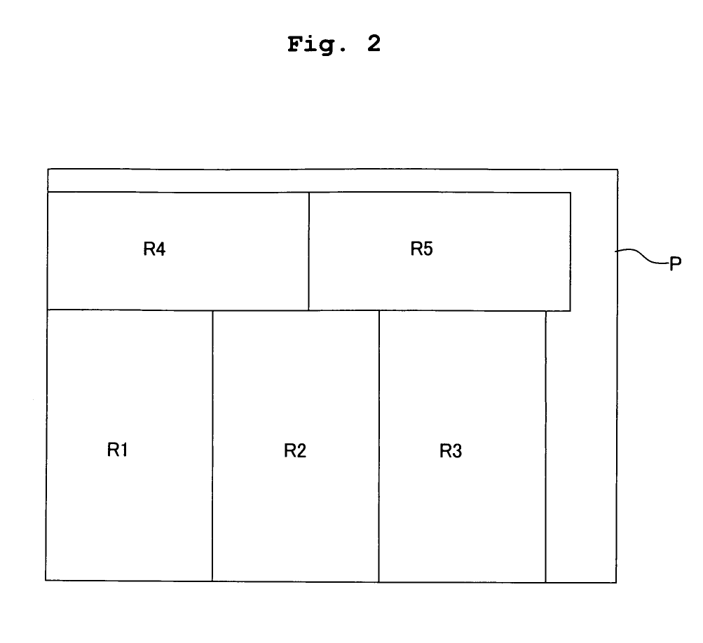

This embodiment is illustrative of an aspect in which the exposure system SS of the device production system shown in FIGS. 1 and 2 is used to expose one piece of the substrate with the primary exposure apparatus EX1 and the secondary exposure apparatus EX2 in a shared manner. That is, the exposure system SS can expose a predetermined first area of the substrate (including at least one shot area) by the primary exposure apparatus EX1 based on the second control mode of the primary controller 6; and in which the exposure system SS can expose a second area (including at least one shot area, with a size and/or an exposing pattern different from those of the first area) other than the predetermined first area by the secondary exposure apparatus EX2. In the following description, the constitutive parts or components, which are same as or equivalent to those of the first embodiment, are designated by the same reference numerals, any explanation of which will be simplified or omitted.

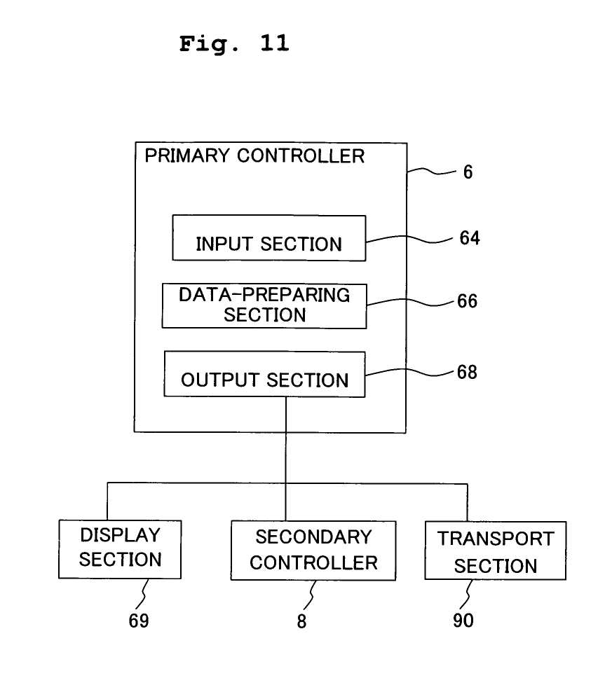

As shown in FIG. 11, the primary controller 6 of the primary exposure apparatus EX1 includes an input section 64 into which the exposure information including the exposure position and the pattern for exposing one substrate therewith is inputted, a data-preparing section 66 which prepares an exposure data for controlling the primary exposure apparatus EX1 and the secondary exposure apparatus EX2 based on the inputted information, and an output section 68 which outputs the prepared exposure data. For example, it is assumed that a glass substrate of 2200 mm×2400 mm is exposed in a layout including three 42-inch screens (shot areas) and two 37-inch screens (shot areas). In this case, the information including the sizes of the screens, the number of the screens, etc. is inputted into the input section 64 by a user. The information may be inputted as the layout information as shown in FIG. 2. FIG. 2 shows a coarse or rough layout in which, for example, the 42-inch screens R1 to R3 and the 37-inch screens R4, R5 are arranged. The data-preparing section 66 judges whether or not such a coarse layout can be exposed by the exposure system. If it is judged that the exposure can be performed, the data, with which the primary exposure apparatus EX1 and the secondary exposure apparatus EX2 are to be controlled, is prepared based on the inputted information.

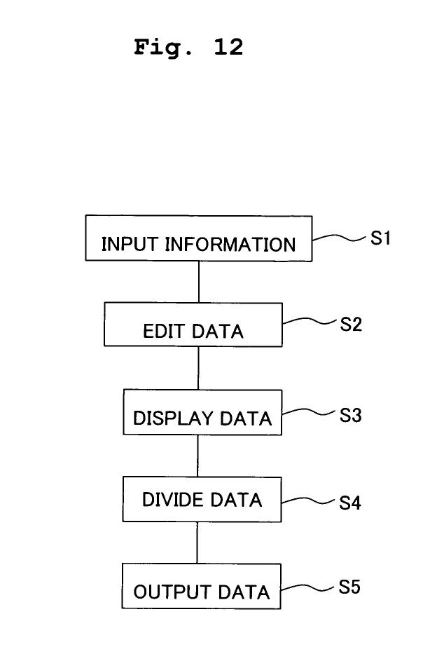

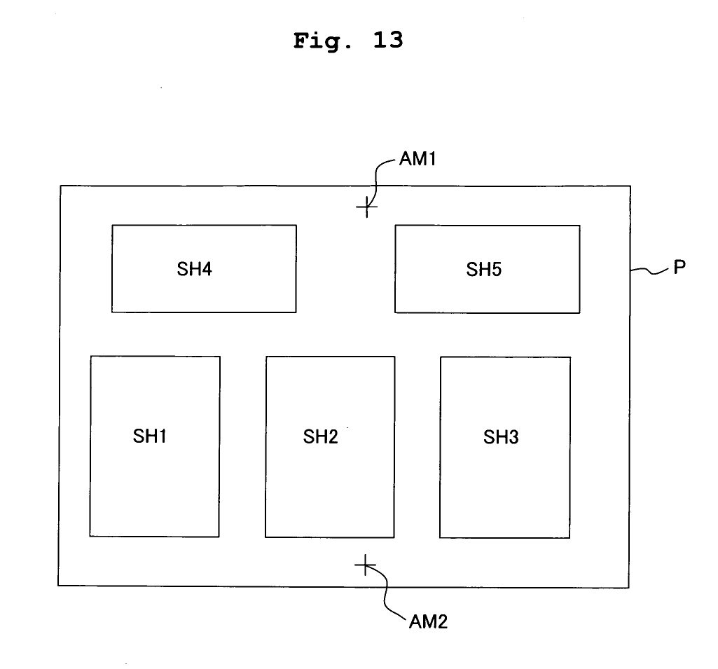

An explanation will be made with reference to FIG. 12 about the contents or details of the information processing (second control mode) in the data-preparing section 66. When the information is inputted into the data-preparing section 66 (S1), the data-preparing section 66 edits the input information to determine the positions at which the screens R1 to R5 are to be arranged on the substrate P (S2). Each of the positions of the screens R1 to R5 on the glass substrate P is determined by a distance from a reference position on the glass substrate P. The reference position may be an edge position of the glass substrate P or the positions of screen-arranging marks AM1, AM2 formed by the mark-forming devices 61 before the exposure of the substrate (see FIG. 13). The data-preparing section 66 determines the position of each of the screens R1 to R5 on the glass substrate P by calculating the distance of each of the screens R1 to R5 from the reference position in relation to the X axis direction and the Y axis direction based on the size and the orientation of each of the screens. For example, when the first layer is exposed by the primary exposure apparatus EX1, it is unnecessary to perform the alignment between the patterns. Therefore, the reference position or positions can be defined as an edge or edges of the substrate P. On the other hand, when the first layer is exposed with the pattern by the secondary exposure apparatus EX2, it is necessary that the pattern is aligned with respect to the pattern (screen) of the first layer formed by the primary exposure apparatus EX1. Therefore, the screen-arranging marks AM1, AM2, which are provided as the reference positions having a higher accuracy, are used. However, when an accurate alignment can be performed in accordance with the edge position of the substrate P, then the edge position of the substrate P can be used as the reference position even when the screen is subjected to the exposure in the secondary exposure apparatus EX2. For example, for the screen R4 shown in FIG. 2, distances dx(R4), dy(R4) in the X axis direction and the Y axis direction from the screen-arranging mark AM1 are determined. The position of each of the screens R1 to R5 may be the central position of the screens or the exposure start position. In this manner, the position of each of the screens R1 to R5 on the glass substrate is determined as the relative position with respect to (or the distance from) the reference position. The arrangement of the screens R1 to R5 on the glass substrate, which is determined as described above, is displayed by the primary controller 6 as the shot areas SH1 to SH5 on the display section 69 (S3). FIG. 13 shows an arrangement (accurate layout) of the shot areas SH1 to SH5 on the glass substrate determined as described above, together with the screen-arranging marks AM1, AM2. The user can confirm the screen layout on the substrate to be dealt with by the two exposure apparatuses (primary exposure apparatus EX1 and secondary exposure apparatus EX2) on the operation screen (display section) of one exposure apparatus (primary exposure apparatus EX1).

If the input information cannot be processed by the exposure system in the data edition (S2), for example, if all of the inputted screens cannot be accommodated in the glass substrate P, then this is displayed on the display section 69 so that the user is informed of this.

Subsequently, the primary controller 6 divides the edited data into a first exposure data for the primary exposure apparatus EX1 and a second exposure data for the secondary exposure apparatus EX2 (S4). The exposure process for the shot areas SH1 to SH3 forming the devices on the substrate P is allotted to the primary exposure apparatus EX1 (or the secondary exposure apparatus EX2) in accordance with the instruction of the user or the selection by the primary controller 6; and the exposure process for the shot areas SH4, SH5 is allotted to the secondary exposure apparatus EX2 (or the primary exposure apparatus EX1). Therefore, the first exposure data is used as a data for controlling the primary exposure apparatus EX1 in order to expose the shot areas SH1 to SH3, and the second exposure data is used as a data for controlling the secondary exposure apparatus EX2 in order to expose the shot areas SH4, SH5. That is, the first exposure data includes the position information of the screens R1 to R3 (position information of the shot areas SH1 to SH3) edited in the data-editing step S2 described above; and the second exposure data includes the position information of the screens R4, R5 (position information of the shot areas SH4, SH5). The first exposure data, which is divided as described above, remains in the primary controller 6, and is used to control the primary exposure apparatus EX1. The second exposure data is outputted to the secondary controller 8 via the output section 68 (S5). In the data-dividing step S4 (or in the data-editing step S2), the exposure schedule of the exposure system SS, which includes the exposure processing times in the primary exposure apparatus EX1 and the secondary exposure apparatus EX2, is determined based on the divided data. The information, which includes such an exposure schedule is outputted from the output section 68 to the transport apparatus 90.

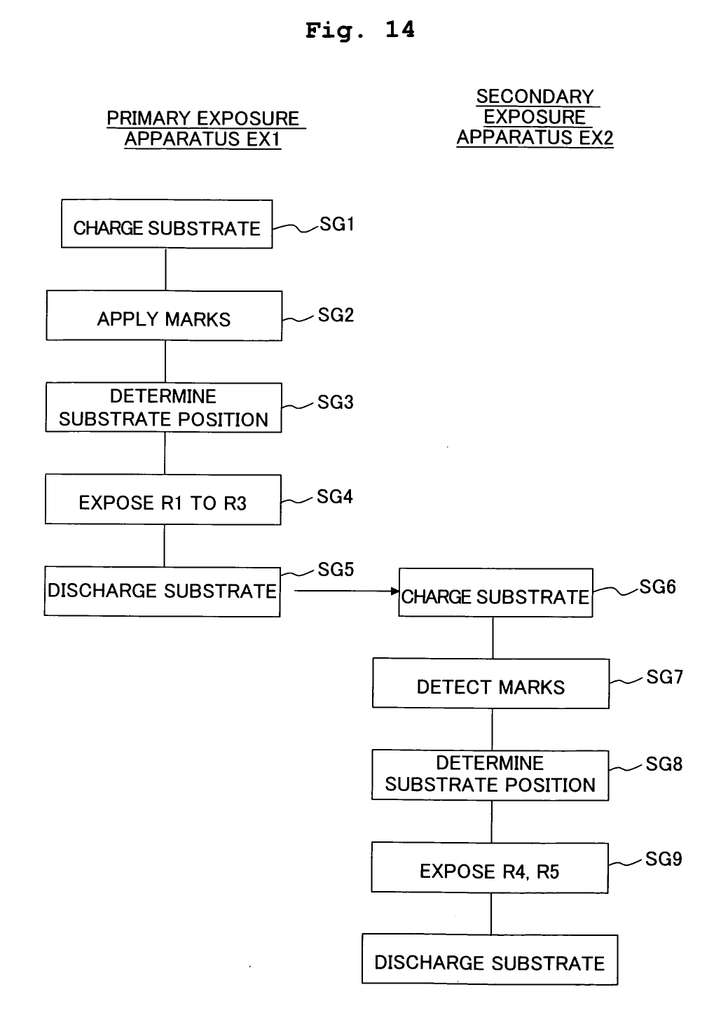

An explanation will be made with reference to FIG. 14 about an operation for performing the exposure by the primary exposure apparatus EX1 and the secondary exposure apparatus EX2 of the exposure system SS shown in FIGS. 6 and 7 based on the exposure data prepared as described above. A glass substrate P, which is coated with the photosensitive material by the coating section C of the coater/developer apparatus CD, is firstly charged or loaded into the primary exposure apparatus EX1 (SG1). In this embodiment, prior to the exposure of the substrate P with the pattern, the screen-arranging marks AM1, AM2 as shown in FIG. 13 are formed on the substrate P by the mark-forming devices 61 provided for the primary exposure apparatus EX1 (SG2). Subsequently, the positions of the shot areas SH1 to SH3, which correspond to the screens R1 to R3 on the substrate P respectively, are determined, with the substrate edge positions as the references, based on the prepared first exposure data (SG3). The substrate edge positions can be detected by using the mark-detecting system (for example, the unillustrated alignment system described above) provided for the primary exposure apparatus EX1. Subsequently, the substrate stage PST moves the substrate P in accordance with the determined position information of the shot area SH1, and the shot area SH1 of the substrate P is positioned with respect to the exposure area AR of the projection optical system PL. That is, the substrate P is positioned at the exposure start position of the shot area SH1. Subsequently, the primary exposure apparatus EX1 exposes the shot area SH1 by synchronously moving the mask M supported by the mask stage MST and the substrate P supported by the substrate stage PST. When the exposure of the shot area SH1 is completed, the substrate stage PST is step-moved to position the substrate stage PST at the exposure start position of the shot area SH2 of the substrate P; and the shot area SH2 is subjected to the scanning exposure in the same manner as in the case of the shot area SH1. When the exposure of the shot area SH2 is completed, the substrate stage PST is step-moved to position the substrate stage PST at the exposure start position of the shot area SH3 of the substrate P; and the shot area SH3 is subjected to the scanning exposure in the same manner as in the case of the shot area SH1 (SG4). In this way, the exposure is executed for the shot areas SH1 to SH3 of the substrate P by the primary exposure apparatus EX1 in accordance with the first exposure data. When the exposure is completed for the shot areas SH1 to SH3, the substrate P is unloaded out of the primary exposure apparatus EX1.

The unloaded substrate P is loaded into the secondary exposure apparatus EX2 by the transport apparatus 90 (SG6). In the secondary exposure apparatus EX2, the screen-arranging marks AM1, AM2 are detected by the mark-detecting devices 62 (SG7). The secondary controller 8 of the secondary exposure apparatus EX2 determines the positions of the shot areas R4, R5 based on the positions of the detected marks AM1, AM2 and the previously prepared second exposure data (SG8). The secondary controller 8 of the secondary exposure apparatus EX2 controls the substrate stage PST to move the substrate P based on the determined position of the shot area R4 and to position the shot area R4 of the substrate P with respect to the exposure area AR of the projection optical system PL. That is, the substrate P is positioned at the exposure start position of the shot area SH4. Subsequently, the secondary exposure apparatus EX2 exposes the shot area SH4 with the pattern of the mask M by synchronously moving the mask M supported by the mask stage MST and the substrate P supported by the substrate stage PST. When the exposure of the shot area SH4 is completed, the substrate stage PST is step-moved to position the substrate stage PST at the shot area SH5 of the substrate P; and the shot area SH5 is subjected to the scanning exposure in the same manner as in the case of the shot area SH4 (SG9). In this way, the exposure is executed for the shot areas SH4, SH5 in the secondary exposure apparatus EX2. When the exposure is completed for the shot areas SH4, SH5, then the substrate P is unloaded out of the secondary exposure apparatus EX2, and the substrate P is loaded into the developing section D of the coater/developer apparatus CD by the transport apparatus 90.

As described above, the primary controller 6 prepares the first exposure data and the second exposure data for exposing the distinct or separate areas of the substrate P in the divided manner by the primary exposure apparatus EX1 and the secondary exposure apparatus EX2; and the primary controller 6 controls the primary exposure apparatus EX1 and the secondary exposure apparatus EX2 based on the first exposure data and the second exposure data as described above (second control mode). Therefore, the exposure system SS can efficiently expose the substrate P by preparing the exposure data with the primary controller 6 or by using the exposure data previously prepared corresponding to the layout, even when a plurality of shot areas on a same substrate include, for example, shot area in which at least one of the type of the exposure pattern, the size, and the layout differs. FIG. 2 shows the substrate in which the size of the device (screen) and the orientation on the substrate P are different. However, it is also allowable to use any substrate which has screens merely having different device patterns. As described above, for example, by allotting the mask patterns, in which the type and/or the size differs, to the two exposure apparatuses respectively to expose the substrate P in the divided manner, it is possible to omit the mask exchange during the exposure operation for one piece of the substrate, and it is unnecessary to prepare a plurality of masks for the exposure apparatuses, respectively.

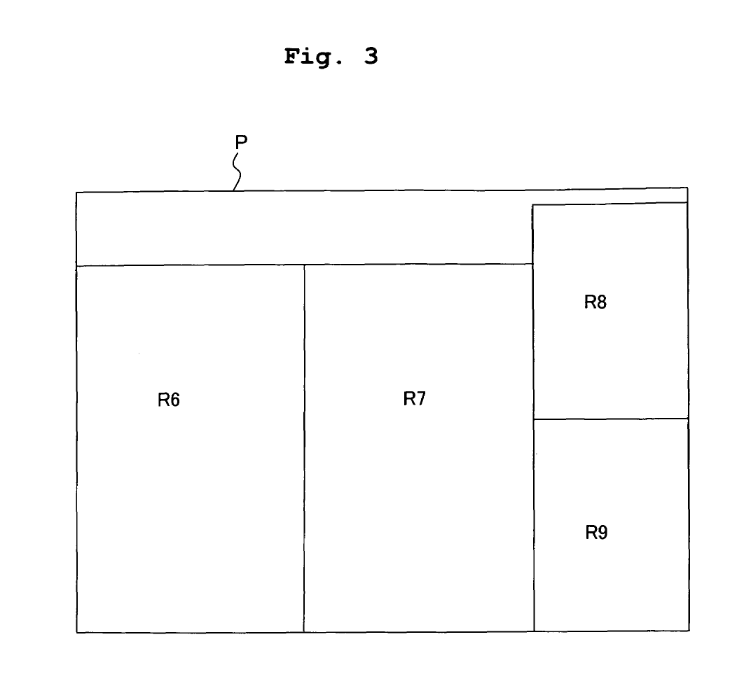

FIG. 3 shows an example of another layout of the substrate P. The primary exposure apparatus EX1 (or the secondary exposure apparatus EX2) can be allotted to the screens (shot areas) R6, R7 on the substrate P shown in FIG. 3 for forming the devices, and the secondary exposure apparatus EX2 (or the primary exposure apparatus EX1) can be allotted to screens (shot areas) R8, R9 for forming the devices. In this case also, the exposure data, which is to be used in order to allow the respective exposure apparatuses to perform the exposure, is prepared by the primary controller 6. As described above, by exposing one substrate P with the different patterns in the different areas on the substrate P in the divided manner by using the primary exposure apparatus EX1 and the secondary exposure apparatus EX2, the exposure can be performed at a high throughput even in the case of a large-sized substrate, and it is possible to improve the efficiency of use of the substrate P.

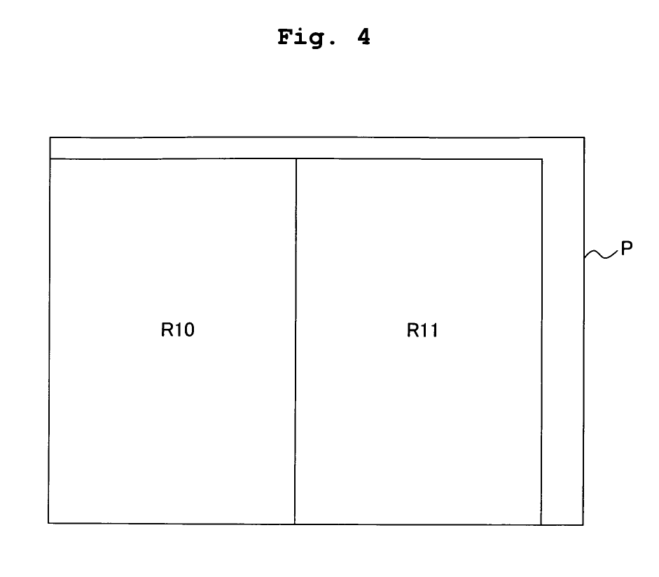

FIG. 4 shows still another exposure layout. As shown in FIG. 4, when screens (shot areas) R10, R11 forming the devices are exposed with different patterns, the first exposure data for performing the exposure with one pattern by the primary exposure apparatus EX1 and the second exposure data for performing the exposure with the other pattern by the secondary exposure apparatus EX2 are prepared. When the screens R10, R11 forming the two devices are exposed with a same pattern, then it is also allowable to prepare the exposure data for performing the exposure by any one of the primary exposure apparatus EX1 and the secondary exposure apparatus EX2 in accordance with the third control mode described above.

The primary controller 6 can prepare the first exposure data and the second exposure data based on the processing abilities (processing times) of the primary exposure apparatus EX1 and the secondary exposure apparatus EX2. For example, each of the exposure data can be prepared so that the exposure apparatus, which is capable of performing the exposure in a short period of time, performs the exposure for a wide screen or a fine pattern. The primary controller 6 outputs the prepared second exposure data to the secondary controller 8 as described above, and the secondary controller 8 controls the exposure by the secondary exposure apparatus EX2 based on the second exposure data outputted from the primary controller 6.

In the embodiment described above, the mark-detecting device 62 is provided independently from the unillustrated alignment system detecting the mark of the photosensitive substrate P. However, the screen-arranging mark may be detected by using another detecting device or system, for example, the alignment system described above, rather than providing the mark-detecting device. A mark-detecting device 61, which constitutes a part of the alignment system as described above, may be used. The mark-forming device 61 may be constructed of, for example, a laser marker, a printing machine or the like. Alternatively, a reference mark of the mask stage MST may be illuminated with the exposure light EL, and the reference mark exposed on the substrate may be used as the screen-arranging mark, rather than providing the mark-forming device. Further alternatively, the screen-arranging mark may be formed beforehand on the substrate before the substrate is loaded into the primary exposure apparatus EX1. In the embodiment described above, the screen-arranging mark may be a latent image formed in the photoresist layer of the substrate, or the screen-arranging mark may be a resist image formed on the substrate via the developing process.

According to the exposure system concerning the second embodiment and the device production system including the same, the primary exposure apparatus is provided with the primary controller which cooperatively controls the primary exposure apparatus, the secondary exposure apparatus, and the transport apparatus. Therefore, it is possible to perform the exposure efficiently, and to improve the throughput. Further, the primary exposure apparatus and the secondary exposure apparatus can expose one piece of the substrate with the different patterns. Therefore, it is possible to improve the efficiency of use of the substrate, and to improve the efficiency of the device production.

The device production system according to the first embodiment is provided with one secondary exposure apparatus EX2. However, it is also allowable to provide two or more of the secondary exposure apparatuses based on the processing time of the coater/developer apparatus CD, the transport time of the transport apparatus 90, the processing time of the primary exposure apparatus EX1, and the processing time of the secondary exposure apparatus. The device production system according to the first embodiment is provided with one coating section and one developing section. However, it is also allowable to provide two or more of the coating sections and two or more of the developing sections based on the processing time of the coater/developer apparatus CD, the processing time of the primary exposure apparatus EX1, and the processing time of the secondary exposure apparatus EX2.

In the device production system according to the embodiment described above, the positions of the screen-arranging marks formed by the mark-forming devices 61 are detected by the mark-detecting devices 62. However, the mark-detecting device 62 may be used to detect the position of the edge of the substrate P. In this case, there is no need to provide the mark-forming device 61, thereby making it possible to make the apparatus to be compact and to lower the cost. The mark-detecting device 61 (or the alignment system or the like as described above, etc.), which detects the screen-arranging mark and/or the edge of the substrate, may be of the image processing system or a system in which a diffracted light or a scattered light generated from the detection objective is detected.

### Third Embodiment

In this embodiment, an explanation will be made about an embodiment in which the primary controller has a plurality of control modes, and the control modes can be selectively switched depending on the instruction of a user or the operation state of the exposure system. In the following description, the constitutive parts or components, which are the same as or equivalent to those of the embodiment described above, are designated by the same reference numerals, any explanation of which will be simplified or omitted. In the first embodiment described above, the primary controller has the first control mode in which the primary exposure apparatus EX1 and the secondary exposure apparatus EX2 are controlled so that the primary exposure apparatus EX1 and the secondary exposure apparatus EX2 alternately deliver the substrates with respect to the transport apparatus, while each of the primary and secondary exposure apparatuses EX1, EX2 exposes the substrate. In a case of the mask pattern or the layout with which the exposure can be performed by one exposure apparatus, it is advantageous to use the first control mode in order to enhance the efficiency of the production line as a whole. In the second embodiment described above, in order to expose one piece of the substrate with the layout having a plurality of different patterns (screens), the plurality of screens are allotted to the primary exposure apparatus EX1 and the secondary exposure apparatus EX2 of the exposure system SS to perform the exposure (second control mode). In the second control mode, especially when a large-sized substrate is subjected to the exposure, it is possible to promptly respond to substrate lots of the different layouts supplied to the production line. However, even in the second control mode, there is a case where it is preferred that the exposure is performed with any one of the apparatuses, depending on the layout and the difference in performance between the primary exposure apparatus EX1 and the secondary exposure apparatus EX2. Further, there is also a situation, due to the circumstance such as the trouble or the like as described above, such that the primary exposure apparatus EX1 or the secondary exposure apparatus EX2 should be temporarily stopped even in the case of the first or second control mode. In such a situation, it is desirable that the primary controller 6 of the primary exposure apparatus EX1 determines which one of the exposure apparatuses to be used to perform the exposure process, prepares the exposure data for the selected or determined exposure apparatus, and transmits the exposure data to the selected exposure apparatus to perform the exposure (third control mode). For example, when any circumstance requiring the stop of the secondary exposure apparatus EX2 arises, then the primary controller 6 prepares the exposure data to perform the exposure by only the primary exposure apparatus EX1, and thus the primary exposure apparatus EX1 performs the exposure based on the exposure data. The primary controller 6 monitors the situation of the secondary exposure apparatus EX2; and when the secondary exposure apparatus EX2 is restored to be in such a state that the operation can be performed, then the primary controller 6 operates the exposure system SS in the two-apparatus operation mode by newly preparing the exposure data, or based on the first exposure data and the second exposure data previously prepared.

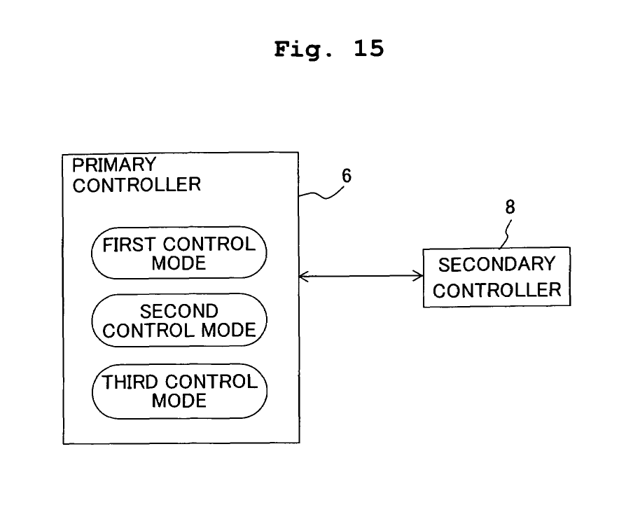

In the exposure system SS of this embodiment, as shown in FIG. 15, the primary controller 6 has the above-described first to third control modes in a switchable manner. The primary controller 6 can selectively switch the modes by receiving the information from the secondary controller 8 or the input section. Since the primary controller 6 has the first to third control modes in the switchable manner as described above, the operation can be performed, without stopping the device production line, by switching to the appropriate mode depending on the type of the device and the operation statuses of the primary exposure apparatus EX1 and the secondary exposure apparatus EX2 in the device production line.

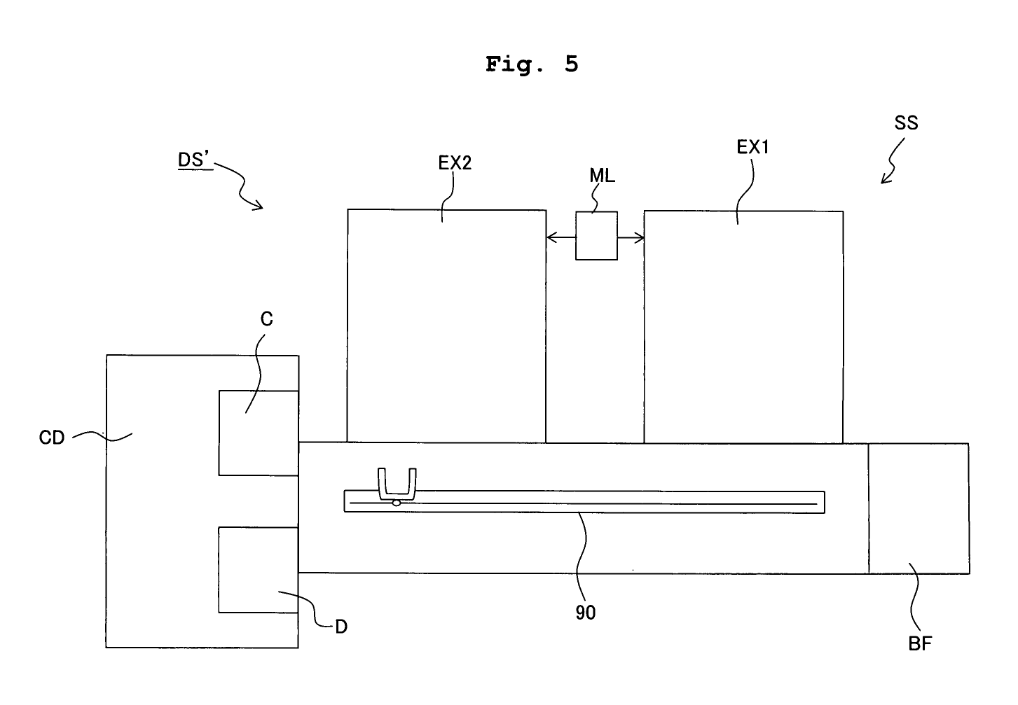

In each of the foregoing embodiments has been explained assuming that the device production system DS is in the arrangement shown in FIG. 1, i.e., in the arrangement in which the primary exposure apparatus EX1 and the secondary exposure apparatus EX2 are opposite to or facing the coater/developer apparatus CD, with the transport apparatus 90 intervening therebetween. However, it is also allowable to adopt an arrangement shown in FIG. 5. In the arrangement of a device production system DS′ shown in FIG. 5, the coater/developer apparatus CD, the primary exposure apparatus EX1, and the secondary exposure apparatus EX2 are arranged along the transport apparatus 90. Further, as shown in FIG. 5, a common mask library ML may be provided, and the mask M may be supplied from the mask library ML to the primary exposure apparatus EX1 and the secondary exposure apparatus EX2. With this arrangement, it is possible to prevent the device production system DS′ from becoming large-sized and consequently the exposure system SS from becoming large-sized which would be otherwise caused by the provision of the two exposure apparatuses. As described above, it is possible to freely design the arrangement of the primary exposure apparatus, the secondary exposure apparatus, the transport apparatus, the coater/developer apparatus, and the substrate stock chamber depending on the installation place of the device production system, etc.

### Fourth Embodiment

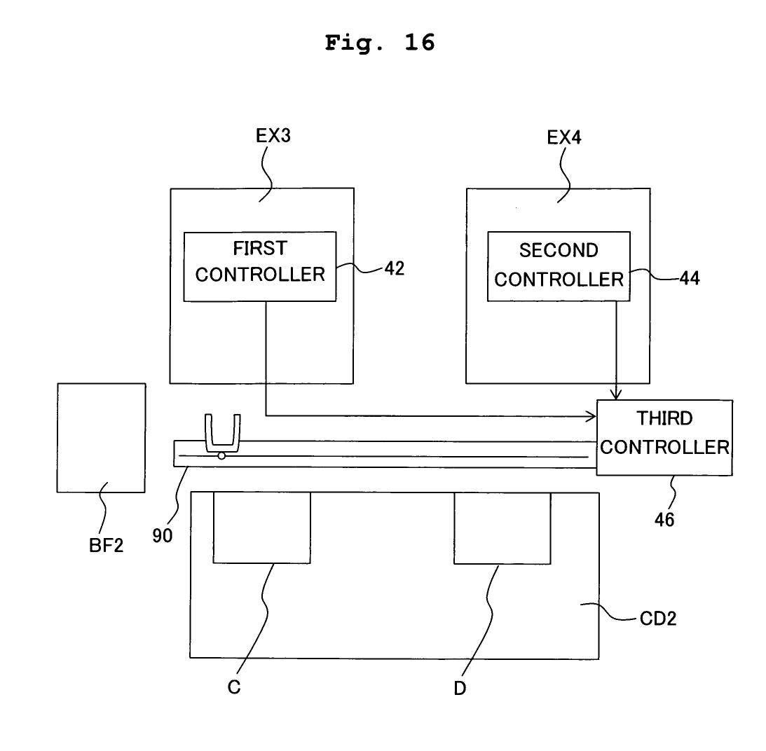

Next, an explanation will be made about a device production system according to a fourth embodiment of the present invention. In the following description, the constitutive parts or components, which are the same as or equivalent to those of the embodiment described above, are designated by the same reference numerals, any explanation of which will be simplified or omitted. FIG. 16 shows the construction of the device production system according to the fourth embodiment. The device production system includes a first exposure apparatus (exposure section) EX3, a second exposure apparatus (exposure section) EX4, a coater/developer apparatus CD2, and a substrate stock chamber BF2 which temporarily stocks the substrates. The device production system further includes a transport apparatus (substrate transport section) 90 which includes at least two transport sections (transport devices, not shown) which transport the substrates between the first and second exposure apparatuses EX3, EX4 and the coater/developer apparatus CD2, and between the first and second exposure apparatuses EX3, EX4 and the substrate stock chamber BF2. The at least two transport sections are constructed so that the substrates can be individually transported with respect to the first exposure apparatus EX3 and the second exposure apparatus EX4 respectively. In this embodiment, the transport apparatus 90 is provided with at least two transport sections. However, the transport apparatus 90 may be provided with one transport section.

The coater/developer apparatus CD2 is constructed in the same manner as the coater/developer apparatus CD according to the first embodiment. Therefore, any detailed explanation thereof will be omitted. A substrate, which is coated with the photoresist by the coating section C, is transported by the transport apparatus 90 to the first exposure apparatus EX3 or the second exposure apparatus EX4.

The pattern of the mask, illuminated with the exposure-illumination light from the illumination system, is transferred via the projection optical system to perform the exposure on the substrate for a flat panel display element by each of the first exposure apparatus EX3 and the second exposure apparatus EX4, the substrate having been transported by the transport apparatus 90 and having a size with an outer diameter exceeding 500 mm. The substrate exposed by the first exposure apparatus EX3 or the second exposure apparatus EX4 is transported to the developing section D provided on the coater/developer apparatus CD2 by the transport apparatus 90.

Masks having mutually different patterns may be used for the first exposure apparatus EX3 and the second exposure apparatus EX4. However, in this embodiment, masks having a same pattern are used in this embodiment. Therefore, the photosensitive substrates are exposed, with the same pattern, in the first exposure apparatus EX3 and the second exposure apparatus EX4 respectively. The first exposure apparatus EX3 and the second exposure apparatus EX4 are constructed in the same manner as the primary exposure apparatus EX1 and the secondary exposure apparatus EX2 explained in the first embodiment described above. Therefore, any explanation of the first and second exposure apparatuses EX3, EX4 will be omitted. The first exposure apparatus EX3 and the second exposure apparatus EX4 may be provided with mask libraries for stocking a plurality of masks formed with different patterns, mask transport sections for transporting the masks (not shown) respectively, etc. Alternatively, the first exposure apparatus EX3 and the second exposure apparatus EX4 may be provided with one mask library and one mask transport section, etc.

The device production system according to this embodiment is provided with the two exposure apparatuses, i.e., the first exposure apparatus EX3 and the second exposure apparatus EX4. However, it is enough that at least one exposure apparatus is provided. The number of the exposure apparatus or exposure apparatuses is determined based on the number of substrates to be transported per unit time by the transport apparatus 90. In this case, the number of substrates to be transported per unit time by the transport apparatus 90 is determined based on the processing ability (processing time) of the coating section C provided on the coater/developer apparatus CD2.

For example, if the time required to coat the substrate with the photosensitive material by the coating section C is 50 seconds, the time interval, at which the substrate is transported from the coater/developer apparatus CD2 by the transport apparatus 90, is set to 50 seconds. That is, the number of substrates to be processed per 10 minutes by the coating section C is twelve, and hence the number of substrates to be transported per 10 seconds by the transport apparatus 90 is set to twelve. The number of the exposure apparatus or exposure apparatuses is determined based on the number of substrates to be transported per unit time by the transport apparatus 90 and the processing ability of the exposure apparatus (number of substrates to be exposed per unit time).

The first exposure apparatus EX3 is provided with a first controller 42 which controls the operation of the first exposure apparatus EX3. Further, the second exposure apparatus EX4 is provided with a second controller 44 which controls the operation of the second exposure apparatus EX4. The transport apparatus 90 is provided with a third controller 46 which controls the operation of the transport apparatus 90. The first controller 42 controls the transport apparatus 90 (third controller 46) so that the substrate is loaded into the first exposure apparatus EX3 when the substrate is not loaded into the first exposure apparatus EX3. That is, the first controller 42 instructs the third controller 46 to load a substrate, which is coated with the photoresist by the coater/developer apparatus CD2, into the first exposure apparatus EX3. The first controller 42 instructs the third controller 46 to load the substrate, which is exposed by the first exposure apparatus EX3, into the coater/developer apparatus CD2 when the exposure of the substrate is completed in the first exposure apparatus EX3.

The second controller 44 controls the transport apparatus 90 (third controller 46) to load the substrate into the second exposure apparatus EX4 when the substrate is not loaded into the second exposure apparatus EX4. That is, the second controller 44 instructs the third controller 46 to load a substrate, which is coated with the photoresist by the coater/developer apparatus CD2, into the second exposure apparatus EX4. The second controller 44 instructs the third controller 46 to load the substrate, which is exposed by the second exposure apparatus EX4, into the coater/developer apparatus CD2 when the exposure of the substrate is completed in the second exposure apparatus EX4.

The third controller 46 loads the substrate into the first exposure apparatus EX3 or the second exposure apparatus EX4, and the third controller unloads the substrate out of the first exposure apparatus EX3 or the second exposure apparatus EX4, based on the instruction from the first controller 42 or the second controller 44.

According to the device production system concerning the fourth embodiment, the two exposure apparatuses are provided. Therefore, it is possible to perform the exposure efficiently, and to improve the throughput. Further, in the fourth embodiment, it is preferable that the exposure is performed alternately by the first exposure apparatus EX3 and the second exposure apparatus EX4 under the first control mode, in the same manner as in the first embodiment. In this case, the shortest processing time is ½ as compared with the conventional apparatus.

In the device production system according to the fourth embodiment, each of the first exposure apparatus EX3 (first controller 42) and the second exposure apparatus EX4 (second controller 44) instructs the transport apparatus 90 (third controller 46) to load and unload the substrate. However, the transport apparatus 90 (third controller 46) may grasp the processing states of the substrates in the first exposure apparatus EX3 and the second exposure apparatus EX4 to load the substrates into the first exposure EX3 and the second exposure apparatus EX4. For example, when the transport apparatus 90 (third controller 46) grasps that the substrate is loaded into the first exposure apparatus EX3 and the substrate is not loaded into the second exposure apparatus EX4, the transport apparatus 90 (third controller 46) loads the substrate into the second exposure apparatus EX4.

The device production system according to the fourth embodiment has been explained as exemplified by the construction shown in FIG. 16 by way of example. However, it is possible to freely design the arrangement positions of the first exposure apparatus, the second exposure apparatus, the transport apparatus, the coater/developer apparatus, and the substrate stock chamber depending on the installation place of the device production system, etc. For example, it is also allowable to adopt the arrangement as shown in FIG. 5.

According to the device production systems concerning the respective embodiments described above, the substrate is exposed in the shared manner by the primary and secondary exposure apparatuses depending on, for example, the layout of the device pattern with which the substrate is to be exposed; or the exposure is performed in the shared manner for every device pattern to be included in one piece of the substrate. Accordingly, it is possible to provide the form the device production system which is most suitable depending on the layout of the device, etc.

The primary exposure apparatus and the secondary exposure apparatus (or the first exposure apparatus and the second exposure apparatus) are not limited to the exposure apparatus provided with the projection optical system of the multilens type. For example, it is also allowable to use an exposure apparatus provided with a projection optical system having one exposure area. In the primary exposure apparatus and the secondary exposure apparatus (or the first exposure apparatus and the second exposure apparatus), the mask M is used to form the first pattern and the second pattern. However, instead of the mask M, it is possible to use a liquid crystal mask or an electronic mask (variable shaped mask) for generating a variable pattern. As such an electronic mask, for example, it is possible to use DMD (Deformable Micro-mirror Device or Digital Micro-mirror Device) which is a kind of the non-light emission type image display element (also referred to as “Spatial Light Modulator (SLM)). DMD has a plurality of reflecting elements (micro-mirrors) which are driven based on the predetermined electronic data. The plurality of reflecting elements are arranged in a two-dimensional matrix form on a surface of DMD, and are driven, with each of the elements as a unit, to reflect and deflect the exposure light EL. The angle of the reflecting surface of each of the reflecting elements is adjusted. The operation of DMD is controlled, for example, by the primary controller and the secondary controller. The primary controller and the secondary controller drive the reflecting elements of DMD respectively based on the electronic data (pattern information) in accordance with the first pattern and the second pattern to be formed on the substrate; and pattern the exposure light EL, radiated by the illumination system IL, with the reflecting elements. By using the DMD, there is no need to perform any mask exchange operation and any operation for adjusting the position of the mask on the mask stage when the pattern is changed, in contrast with the case in which the exposure is performed by using a mask (reticle) formed with the pattern. Therefore, when the lots of different patterns are supplied to the device production line, it is possible to perform the operation more efficiently. The exposure apparatus using DMD is disclosed, for example, in Japanese Patent Application Laid-open Nos. 8-313842 and 2004-304135 and U.S. Pat. No. 6,778,257. The contents of U.S. Pat. No. 6,778,257 is incorporated herein by reference within a range of permission of the domestic laws and ordinances of the designated state or the selected state.

In the respective embodiments described above, although the interferometer system is used to measure the position information about the mask stage and the substrate stage, there is no limitation to this. For example, it is also allowable to use an encoder system which detects a scale (diffraction grating) provided on the upper surface of the substrate stage. In this case, it is preferable that a hybrid system including both of the interferometer system and the encoder system, and the measurement result of the encoder system is calibrated (subjected to the calibration) by using the measurement result of the interferometer system. The position control of the substrate stage may be performed by switchingly using the interferometer system and the encoder system or using both of the interferometer system and the encoder system.

In the respective embodiments described above, it is allowable to use, as the exposure light, lights (light beams) emitted from various light sources as the exposure light; and the ArF excimer laser may be used as the light source device generating the ArF excimer laser beam. However, it is also allowable to use a high harmonic wave generator which includes, for example, a solid laser light source such as a DFB semiconductor laser or a fiber laser, a light-amplifying section having a fiber amplifier or the like, and a wavelength-converting section and which outputs a pulse light having a wavelength of 193 nm as disclosed, for example, in U.S. Pat. No. 7,023,610 (corresponding to International Publication No. 1999/46835). Further, in the embodiment described above, each of the irradiation areas and the exposure area AR described above are rectangular. However, it is also allowable to adopt any other shape including, for example, trapezoidal, circular-arc shaped, parallelogramic, and rhombic forms, etc.

The substrate P, which is usable in the respective embodiments described above, is not limited to the glass substrate for the display device. Those applicable include a semiconductor wafer for producing a semiconductor device, a ceramic wafer for a thin film magnetic head, a master plate (synthetic quartz, silicon wafer) for the mask or the reticle to be used for the exposure apparatus, a film member, and the like. The shape of the substrate P is not limited to the rectangular shape, and may be any other shape including circular shapes, etc.

The projection optical system PL is not limited to the 1× magnification system, and may be either a reduction system or a magnification system. Further, the projection optical system PL may be any one of the dioptric system, the catoptric system, and the catadioptric system. The projected image may be either an erecting image or an inverted image. As for the projection optical system PL, when the far ultraviolet light such as the excimer laser is used, a material such as silica glass, calcium fluoride, etc. through which the far ultraviolet light is transmissive, may be used as the lens material. When the F2 laser is used, it is possible to adopt an optical system of the catadioptric system or the dioptric system.

When the linear motor is used for the substrate stage PST and/or the mask stage MST, it is allowable to use any one of those of the air floating type using the air bearing and those of the magnetic floating type using the Lorentz's force or the reactance force. Each of the stages may be either of a type in which the movement is effected along the guide or of a guideless type in which no guide is provided.

When a plane motor is used as the driving apparatus of the stage, any one of the magnet unit and the armature unit may be connected to the stage, and the other of the magnet unit and the armature unit may be provided on the side of the movable surface of the stage (base).

The reaction force, which is generated in accordance with the movement of the substrate stage PST, may be mechanically released to the floor (ground) by using a frame member, as described in U.S. Pat. No. 6,281,654 (and in Japanese Patent Application Laid-open No. 8-166475 corresponding thereto). The present invention is also applicable to the exposure apparatus provided with such a structure.

The reaction force, which is generated in accordance with the movement of the mask stage MST, may be mechanically released to the floor (ground) by using a frame member, as described in U.S. Pat. No. 6,246,205 (and Japanese Patent Application Laid-open No. 8-330224 corresponding thereto). The present invention is also applicable to the exposure apparatus provided with such a structure.

The present invention is also applicable to an exposure apparatus of the twin-stage (multi-stage) type provided with a plurality of substrate stages as disclosed, for example, in U.S. Pat. Nos. 6,341,007, 6,400,441, 6,549,269, and 6,590,634 (corresponding to Japanese Patent Application Laid-open Nos. 10-163099 and 10-214783), and in U.S. Pat. No. 5,969,441 (corresponding to Published Japanese Translation of PCT International Publication for Patent Application No. 2000-505958. In relation to the multi-stage type exposure apparatus, the contents of U.S. Pat. Nos. 6,341,007, 6,400,441, 6,549,269, 6,590,634 and 5,969,441 are incorporated herein by reference within a range of permission of the domestic laws and ordinances of the designated state and the selected state.

Further, the present invention is also applicable to an exposure apparatus provided with a substrate stage which holds the substrate and a measuring stage which is provided with a measuring member or members (for example, a reference member formed with a reference mark and/or various photoelectric sensors), as disclosed, for example, in Japanese Patent Application Laid-open No. 11-135400 (corresponding to International Publication No. 1999/23692) and U.S. Pat. No. 6,897,963 (corresponding to Japanese Patent Application Laid-open No. 2000-164504). The contents of U.S. Pat. No. 6,897,963 is incorporated herein by reference within a range of permission of the domestic laws and ordinances of the designated state or the selected state.

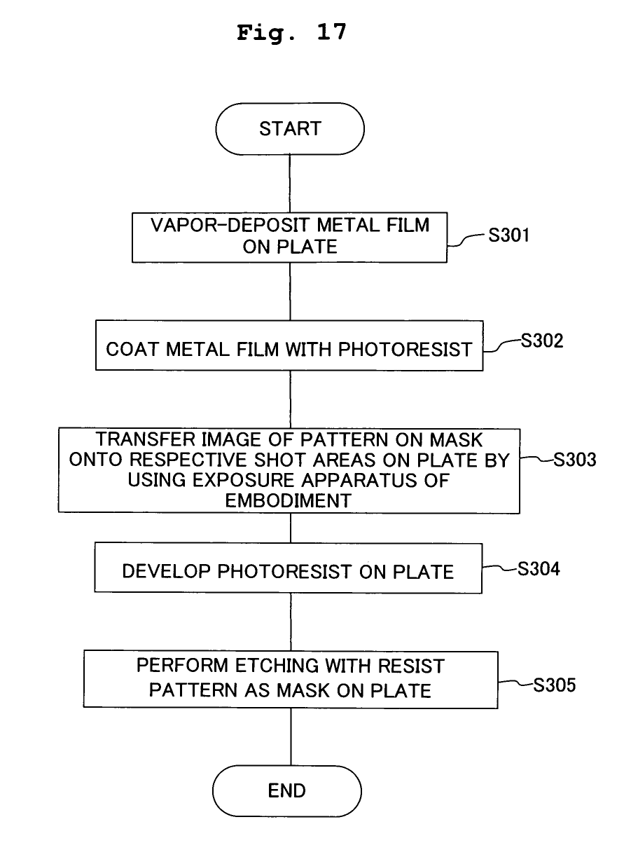

In the device production systems according to the respective embodiments described above, a microdevice (semiconductor element, image pickup element, liquid crystal display element, thin film magnetic head, etc.) can be produced by exposing (performing the exposing step for) a photosensitive substrate (plate) with a transferring pattern formed on a reticle (mask) by using the projection optical system. An explanation will be made below with reference to a flow chart shown in FIG. 17 about an example of the technique adopted when the semiconductor device as the microdevice is obtained by forming a predetermined circuit pattern on the plate or the like as the photosensitive substrate, by using any one of the device production systems according to the respective embodiments described above.

At first, in Step S301 shown in FIG. 17, a metal film is vapor-deposited on a plate of one lot. Subsequently, in Step S302, the metal film on the plate of one lot is coated with the photoresist by the coating section provided for the coater/developer apparatus. The plate is transported by the transport apparatus from the coater/developer apparatus to the exposure apparatus. After that, in Step S303, the image of the pattern of the mask is successively transferred onto the respective shot areas on the plate of one lot to perform the exposure via the projection optical system by using the exposure apparatus provided for any one of the device production systems according to the respective embodiments described above. After that, in Step S304, the photoresist on the plate of one lot is developed by the developing section provided for the coater/developer apparatus, and then the etching is performed, by using the resist pattern as the mask, on the plate of one lot in Step S305. Accordingly, the circuit pattern, which corresponds to the pattern of the mask, is formed in each of the shot areas of each plate.

After that, the formation of the circuit pattern is performed on the upper layer, etc; and a plurality of devices are cut out from the plate to produce the devices such as the semiconductor elements. According to the method for producing the semiconductor device described above, the device is produced by using any one of the device production systems according to the respective embodiments described above. Therefore, the satisfactory semiconductor device can be obtained at a high throughput. In Steps S301 to S305, the metal is vapor-deposited on the plate, the metal film is coated with the resist, and the respective steps of exposure, development, and etching are performed. However, it goes without saying that a silicon oxide film may be formed on the plate prior to the foregoing steps, the silicon oxide film may be coated with the resist, and the respective steps of exposure, development, and etching may be performed.

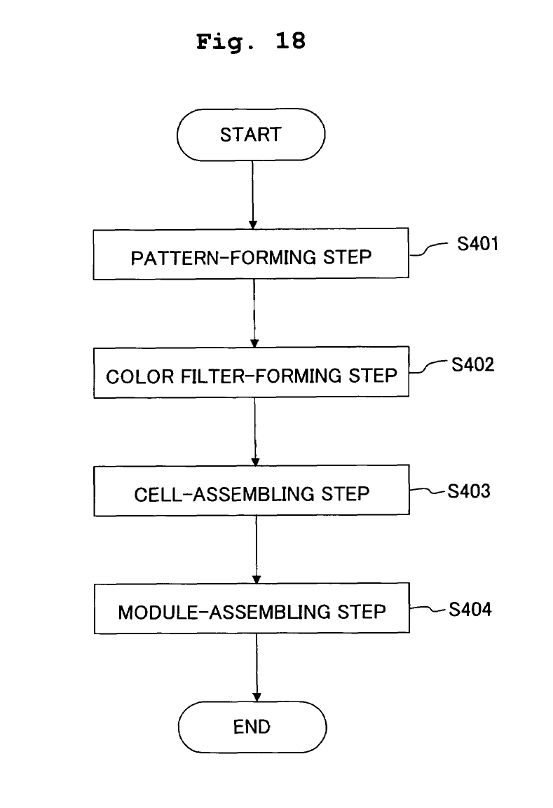

In the device production systems according to the respective embodiments described above, a liquid crystal display element can be also obtained as the microdevice by forming a predetermined pattern (circuit pattern, electrode pattern, etc.) on the plate (glass substrate). An explanation will be made below with reference to a flow chart shown in FIG. 18 about an example of the technique adopted in this procedure. At first, with reference to FIG. 18, in a pattern-forming step S401, the so-called photolithography step is executed, in which a pattern of the mask is transferred onto the photosensitive substrate (glass substrate coated with the resist) to perform the exposure by using the exposure apparatus provided for any one of the device production systems according to the respective embodiments described above. A predetermined pattern, which includes a large number of electrodes, etc., is formed on the photosensitive substrate by the photolithography step. After that, the exposed substrate is transported by the transport apparatus to the developing section provided for the coater/developer apparatus; and the respective steps, which include the developing step, the etching step, the resist exfoliation step, etc., are performed by the developing section, thereby forming the predetermined pattern on the substrate. The procedure is allowed to proceed to the next color filter-forming step S402.

Subsequently, in the color filter-forming step S402, a color filter is formed such that a large number of sets of three types of dots, which correspond to R (Red), G (Green), and B (Blue), are arranged in a matrix form, or a plurality of sets of filters, which are composed of three types of stripes of R, G, and B, are arranged in the horizontal scanning line direction. Then, a cell-assembling step S403 is executed after the color filter-forming step S402. In the cell-assembling step S403, a liquid crystal panel (liquid crystal cell) is assembled by using, for example, the substrate having the predetermined pattern obtained in the pattern-forming step S401 and the color filter obtained in the color filter-forming step S402. In the cell-assembling step S403, for example, a liquid crystal panel (liquid crystal cell) is produced by injecting the liquid crystal into a space between the substrate having the predetermined pattern obtained in the pattern-forming step S401 and the color filter obtained in the color filter-forming step S402.

After that, the liquid crystal display element is completed in a module-assembling step S404 by attaching respective parts including a backlight, an electric circuit for allowing the assembled liquid crystal panel (liquid crystal cell) to perform the display operation, etc. According to the method for producing the liquid crystal display element as described above, the device is produced by using any one of the device production systems according to the respective embodiments described above. Therefore, the satisfactory liquid crystal display element can be obtained at a high throughput.

According to the exposure system of the present invention, the exposure of the substrate can be realized at a high efficiency. Therefore, the device, which has a complicated circuit pattern at a high density to be used for the liquid crystal display element, the micromachine and the like can be produced at a high throughput. Therefore, the present invention remarkably contributes to the development of the precision mechanical equipment industry including the semiconductor industry of our country.

What is claimed is:

1. A device production system comprising:
a substrate transport section which transports substrates;
a plurality of exposure sections which are capable of exposing the substrates respectively; and
a controller which cooperatively controls the substrate transport section and the plurality of exposure sections so that operation states of the plurality of exposure sections are in desired states.

2. The device production system according to claim 1, wherein the controller performs control based on a number of the substrates to be transported by the substrate transport section and a number of the substrates to be exposed by each of the plurality of exposure sections.

3. The device production system according to claim 1, wherein the controller selects at least one exposure section of the plurality of exposure sections in accordance with substrate processing information of the plurality of exposure sections, and the controller controls the substrate transport section so that the substrates are transported to the selected exposure section.

4. The device production system according to claim 3, wherein the substrate processing information includes at least one of an exposure time per one piece of the substrates to be exposed by each of the plurality of exposure sections and apparatus-trouble information.

5. The device production system according to claim 1, wherein the controller controls the substrate transport section so that the substrates are transported in accordance with substrate processing requests from the plurality of exposure sections respectively.

6. The device production system according to claim 1, wherein the controller controls the substrate transport section so that the substrates are transported successively to the plurality of exposure sections.

7. The device production system according to claim 1, wherein the substrate transport section is provided with a plurality of substrate transport devices each of which is capable of individually transporting one of the substrates; and
the controller controls operation states of the plurality of substrate transport devices and the plurality of exposure sections in accordance with a number of the substrates to be processed per unit time in the device production system.

8. The device production system according to claim 1, wherein the plurality of exposure sections are capable of performing exposure with different patterns respectively.

9. The device production system according to claim 1, wherein each of the substrates is exposed with a plurality of different patterns; and
the controller selects the plurality of exposure sections for each of the plurality of patterns to perform the exposure.

10. The device production system according to claim 8, wherein at least one mask transport section, which transports a plurality of masks having the different patterns provided thereon respectively, is provided for the plurality of exposure sections.

11. The device production system according to claim 1, wherein one exposure section of the plurality of exposure sections is designated as a primary exposure section, and remaining exposure sections of the plurality of exposure sections are designated as secondary exposure sections; and
the primary exposure section has a mark-applying section which applies, to each of the substrates, a mark which is usable in each of the secondary exposure sections.

12. The device production system according to claim 1, wherein the plurality of exposure sections includes:
a first exposure section which uses a mask having a pattern depicted thereon; and
a second exposure section which uses a variable shaped mask capable of performing exposure with an arbitrary pattern.

13. The device production system according to claim 1, wherein the plurality of exposure sections expose areas to be exposed on each of the substrates, such that the areas are exposed by the exposure sections in a shared manner.

14. The device production system according to claim 13, wherein the plurality of exposure sections include at least a primary exposure section and a secondary exposure section;
the controller includes a primary controller which controls the primary exposure section and a secondary controller which controls the secondary exposure section; and
the primary controller divides exposure data, with which each of the substrates is exposed, into primary exposure data for the primary controller and secondary exposure data for the secondary controller in accordance with the shared manner in which the areas on each of the substrates are exposed.

15. The device production system according to claim 1, wherein each of the substrates is a substrate for a flat panel display element.

16. The device production system according to claim 1, wherein each of the substrates has an outer diameter which exceeds 500 mm.

17. A device production method comprising:
an exposing step of exposing substrates with a predetermined pattern by using the device production system as defined in claim 1; and
a developing step of developing the substrate exposed in the exposing step.

18. An exposure system which performs a substrate exposure process to expose substrates and which delivers the substrates with respect to an external processing apparatus performing another process different from the substrate exposure process, the exposure system comprising:
first and second exposure sections each of which exposes one of the substrates; and
a controller which controls the first and second exposure sections so that the first and second exposure sections alternately receive the substrates from the external processing apparatus and discharge the substrates to the external processing apparatus.

19. The exposure system according to claim 18, further comprising a transport section which transports each of the substrates between the external processing apparatus and the first or second exposure section,
wherein the transport section performs the reception of each of the substrates from the external processing apparatus to one of the first and second exposure sections and the discharge of each of the substrates from one of the first and second exposure sections to the external processing apparatus.

20. The exposure system according to claim 18, wherein a processing time per one piece of the substrates in the external processing apparatus is shorter than each of processing time per one piece of the substrates in each of the first and second exposure sections.

21. The exposure system according to claim 20, wherein the processing time per one piece of the substrates in each of the first and second exposure sections is shorter than twice the processing time per one piece of the substrates in the external processing apparatus.

22. The exposure system according to claim 18, wherein the first and second exposure sections alternately receive the substrates each of which is supplied, per every constant period of time, from the external processing apparatus.

23. The exposure system according to claim 22, wherein a part of the substrate exposure process is performed concurrently in the first and second exposure sections; and
each of the first and second exposure sections starts to discharge one of the exposed substrates before a process for another substrate, to be exposed next to the exposed substrates, is completed in the external processing apparatus.

24. The exposure system according to claim 23, wherein a period of time, in which the part of the substrate exposure process is performed concurrently in the first and second exposure sections, is shorter than the constant period of time.

25. The exposure system according to claim 22, wherein the constant period of time is approximately same as a processing time per one piece of the substrates in the external processing apparatus.

26. The exposure system according to claim 22, wherein the substrates, which are exposed alternately in the first and second exposure sections, are discharged to the external processing apparatus at a constant interval corresponding to a processing time per one piece of the substrates in the external processing apparatus.

27. The exposure system according to claim 18, wherein each of the exposed substrates is discharged, in a constant processing time, from the exposure system irrelevant to exposure processing time in each of the first and second exposure sections.

28. The exposure system according to claim 18, wherein the controller controls an operation in the second exposure section based on an operation in the first exposure section.

29. The exposure system according to claim 18, wherein when failure arises in one of the first and second exposure sections, the controller controls the first and second exposure sections so that the substrate exposure process is executed only in the other of the first and second exposure sections without allowing the first and second exposure sections to alternately perform the reception and the discharge of the substrates.

30. An exposure system which exposes a substrate, the exposure system comprising:
first and second exposure sections which expose, with a plurality of patterns, one piece of the substrate in a shared manner;
an exposure data-preparing section which prepares first exposure data and second exposure data, for exposing the substrate by the first and second exposure sections respectively in the shared manner, in accordance with exposure information of one piece of the substrate inputted into the exposure system; and
a controller which controls the first exposure section and the second exposure section based on the first exposure data and the second exposure data prepared by the exposure data-preparing section.

31. The exposure system according to claim 30, wherein the plurality of patterns include a first pattern which is subjected to exposure in the first exposure section and a second pattern which is subjected to the exposure in the second exposure section;
the first exposure data includes position information of the first pattern on the substrate; and
the second exposure data includes position information of the second pattern on the substrate.

32. The exposure system according to claim 31, wherein the position data of the first pattern on the substrate includes information about a distance of the first pattern from an edge of the substrate.

33. The exposure system according to claim 31, further comprising a mark-forming device which forms an alignment mark on the substrate to align the second pattern with respect to the first pattern.

34. The exposure system according to claim 33, wherein the position data of the second pattern on the substrate includes information about a distance of the second pattern from the alignment mark formed on the substrate.

35. The exposure system according to claim 30, wherein the controller controls an operation in the second exposure section based on an operation in the first exposure section.

36. The exposure system according to claim 31, wherein the substrate is exposed with the first pattern in the first exposure section and then is transported to the second exposure section, and the substrate is exposed with the second pattern in the second exposure section.

37. The exposure system according to claim 31, further comprising a display section, wherein the display section displays the patterns which are subjected to the exposure in the first and second exposure sections based on the prepared exposure data.

38. The exposure system according to claim 30, wherein areas, on the substrate, which are exposed with the first and second patterns respectively have different sizes.

39. An exposure system which exposes substrates, the exposure system comprising:
first and second exposure sections each of which exposes one of the substrates; and
a controller which controls the first and second exposure sections;
the controller having, in a switchable manner, a first control mode in which the first and second exposure sections are controlled so that a substrate, among the substrates, which is loaded and exposed in the first exposure section and unloaded out of the first exposure section is different from a substrate loaded and exposed in the second exposure station and unloaded out of the second exposure section, and in which the first and second exposure sections alternately perform reception of the substrate from an external processing apparatus and discharge of the substrate to the external processing apparatus, the external processing apparatus performing a process different from the exposure of the substrate; and
a second control mode in which the substrate loaded in the first exposure section is same as the substrate loaded in the second exposure section, and different areas of the substrate are exposed in a shared manner between the first and second exposure sections.

40. The exposure system according to claim 39, wherein the controller has, in a switchable manner, a third control mode in which the first and second exposure sections are controlled so that the exposure is performed in only one of the first and second exposure sections.

41. The exposure system according to claim 18, wherein the external processing apparatus is a coating apparatus and/or a developing apparatus.

42. The exposure system according to claim 18, wherein the substrate is a substrate for a flat panel display.

43. The exposure system according to claim 18, wherein the substrate has an outer diameter which exceeds 500 mm.

44. A device production method comprising:
an exposing step of exposing a substrate with a predetermined pattern by using the exposure system as defined in claim 18; and
a developing step of developing the substrate exposed in the exposing step.

45. An exposure method for exposing substrates, supplied from an external apparatus, by an exposure apparatus, the exposure method comprising:
supplying the substrates alternately to a first exposure section and a second exposure section from the external apparatus at intervals of time to;
exposing each of the substrates with a predetermined pattern in one of the first exposure section and the second exposure section to which the substrates are alternately supplied; and
discharging the exposed substrates alternately from the first exposure section and the second exposure section;
wherein an exposure processing time t₁ in the first exposure section and an exposure processing time t₂ in the second exposure section satisfy t₁, t₂>t₀.

46. The exposure method according to claim 45, wherein the predetermined pattern subjected to the exposure in the first exposure section is same as that subjected to the exposure in the second exposure section.

47. The exposure method according to claim 45, wherein each of the substrates is discharged at a constant time interval from one of the first exposure section and the second exposure section.

48. The exposure method according to claim 45, further comprising switching control of the first and second exposure sections, when failure arises in one of the first and second exposure sections, so that the exposure is performed only in the other of the first and second exposure sections without allowing the first and second exposure sections to alternately perform the reception and discharge of the substrates.

49. The exposure method according to claim 45, wherein a part of an exposure process for exposing the substrates is performed concurrently in the first and second exposure sections; and
each of the first and second exposure sections starts to discharge one of the exposed substrates before a process for another substrate to be exposed next to the exposed substrates is completed in the external apparatus.

50. The exposure method according to claim 49, wherein a period of time, in which the part of the exposure process for the substrates is performed concurrently in the first exposure section and the second exposure section, is shorter than the time t₀.

51. The exposure method according to claim 45, wherein each of the substrates, exposed alternately in the first exposure section and the second exposure section, is discharged from the exposure apparatus at a constant interval corresponding to a processing time per one piece of the substrates in the external apparatus.

52. An exposure method comprising:
exposing different substrates in a first exposure station and a second exposure station, respectively, of an exposure apparatus; and
switching, depending on a change of a layout of a pattern to be formed on a substrate among the different substrates, between a first control mode of the exposure apparatus in which the different substrates are alternately exposed and discharged from first and second exposure sections and a second control mode in which different areas of a substrate among the substrates are exposed in a shared manner in the first and second exposure sections.

53. The exposure method according to claim 45, wherein the external apparatus is a coating apparatus and/or a developing apparatus.

54. The exposure method according to claim 45, wherein the substrate is a substrate for a flat panel display.

55. The exposure method according to claim 45, wherein the substrate has an outer diameter which exceeds 500 mm.

56. A device production method comprising:
coating a substrate with a photosensitive material by using the external apparatus as defined in claim 45;
exposing the substrate by using the exposure method as defined in claim 45; and
developing the exposed substrate.

57. A device production system comprising:
the exposure system as defined in claim 18;
a coater/developer apparatus which coats a substrate with a photosensitive material before an exposure process performed in the exposure system and which develops the substrate after the exposure process; and
a transport apparatus which transports the substrate with respect to the exposure system and the coater/developer apparatus.

58. The device production system according to claim 57, wherein the substrate has an outer diameter which exceeds 500 mm, and the substrate is used to form a flat panel display device.

59. The exposure system according to claim 30, wherein the external processing apparatus is a coating apparatus and/or a developing apparatus.

60. The exposure system according to claim 30, wherein the substrate is a substrate for a flat panel display.

61. The exposure system according to claim 30, wherein the substrate has an outer diameter which exceeds 500 mm.

62. A device production method comprising:
an exposing step of exposing a substrate with a predetermined pattern by using the exposure system as defined in claim 30; and
a developing step of developing the substrate exposed in the exposing step.

63. The exposure system according to claim 39, wherein the external processing apparatus is a coating apparatus and/or a developing apparatus.

64. The exposure system according to claim 39, wherein the substrate is a substrate for a flat panel display.

65. The exposure system according to claim 39, wherein the substrate has an outer diameter which exceeds 500 mm.

66. A device production method comprising:
an exposing step of exposing a substrate with a predetermined pattern by using the exposure system as defined in claim 39; and
a developing step of developing the substrate exposed in the exposing step.

67. The exposure method according to claim 52, wherein the external apparatus is a coating apparatus and/or a developing apparatus.

68. The exposure method according to claim 52, wherein the substrate is a substrate for a flat panel display.

69. The exposure method according to claim 52, wherein the substrate has an outer diameter which exceeds 500 mm.

70. A device production system comprising:
the exposure system as defined in claim 30;
a coater/developer apparatus which coats a substrate with a photosensitive material before an exposure process performed in the exposure system and which develops the substrate after the exposure process; and
a transport apparatus which transports the substrate with respect to the exposure system and the coater/developer apparatus.

71. A device production system comprising:
the exposure system as defined in claim 39;
a coater/developer apparatus which coats a substrate with a photosensitive material before an exposure process performed in the exposure system and which develops the substrate after the exposure process; and
a transport apparatus which transports the substrate with respect to the exposure system and the coater/developer apparatus.

72. The device production system according to claim 70, wherein the substrate has an outer diameter which exceeds 500 mm, and the substrate is used to form a flat panel display device.

73. The device production system according to claim 71, wherein the substrate has an outer diameter which exceeds 500 mm, and the substrate is used to form a flat panel display device.
